(19) United States
(12) Patent Application Publication
(10) Pub. No.: US 2022/0014524 A1
(43) Pub. Date: Jan. 13, 2022

(54) Secure Communication Using Device-Identity Information Linked To Cloud-Based Certificates

(71) Applicant: Averon US, Inc., Henderson, NV (US)

(72) Inventors: Wendell Brown, Henderson, NV (US); Mark KLEIN, Henderson, NV (US)

(21) Appl. No.: 17/219,598

(22) Filed: Mar. 31, 2021

Related U.S. Application Data
(63) Continuation of application No. 16/379,163, filed on Apr. 9, 2019, now abandoned.
(60) Provisional application No. 62/654,990, filed on Apr. 9, 2018.

(51) Int. Cl. H04L 29/06; H04W 12/043

(52) U.S. Cl. CPC H04L 63/102; H04L 63/0823; H04W 12/72; H04L 63/20; H04W 12/043; H04L 63/045

(57) ABSTRACT

Embodiments of the present disclosure provide methods, systems, apparatuses, and computer program products to manage storage of certificate information, including at least a public key and private key, in a manner associated with device-identity information and facilitate secure communication between a user device and a service provider device. A device-identity management system may be provided to receive a secure key request over a carrier network from a user device, the secure key request including device-identity information injected by a carrier device of the carrier network via header enrichment. The device-identity management system may retrieve, from a secured key storage, the private key associated with the device-identity information. The device-identity management system may transmit, from the device-identity management system to the user device over a secured network, secure key information based on the private key. The secure key information may be used for secure communication.

### CROSS-REFERENCE TO RELATED APPLICATIONS

This application claims priority to U.S. Provisional Application No. 62/654,990 filed Apr. 9, 2018, the content of which is incorporated herein by reference in its entirety.

### TECHNOLOGICAL FIELD

Embodiments of the present disclosure relate, generally, to generating and managing Public-Key Interface (“PKI”) certificate information, including a private key and public key, associated with device-identity information, and using the private key and/or public key in establishing a secured connection between a user device and a service provider device for transmitting secured communications.

### BACKGROUND

Typically, a service provider device cannot verify the identity of a user device attempting to connect to the service provider device, and therefore cannot verify the identity of the user possessing the user device. Conventional systems for facilitating such identification have required significant technical expertise, and thus limited adoption of secure identification methods.

The applicant has discovered problems with current systems, methods, and apparatuses and through applied effort, ingenuity, and innovation, Applicant has solved many of these identified problems by developing a solution that is embodied by the present invention, which is described in detail below.

### BRIEF SUMMARY

In general, embodiments of the present invention provided herein include systems, methods, apparatuses, and computer readable media for managing certificate information associated with device-identity information for use in verifying a user device identity and establishing a secured connection between a user device and a service provider device for transmitting secured communications.

Other systems, methods, and features will be, or will become, apparent to one with skill in the art upon examination of the following figures and detailed description. It is intended that all such additional systems, methods, and other features be included within this description, be within the scope of the disclosure, and be protected by the following claims.

In some embodiments, a device-identity management system may be provided to manage storage of certificate information in a manner associated with device-identity information and facilitate secure communication between a user device and a service provider device. The system may include at least one processor and at least one memory, the at least one memory having computer-coded instructions therein. The computer-coded instructions, when executed by the processor, cause the system to receive, at the device-identity management system, from the user device, a secure key request indicative of access by the user device of a link configured by the service provider device in response to the service provider device receiving a request for services from the user device. The secure key request may comprise at least device-identity information, and the secure key request may be transmitted from the user device over a carrier network comprising at least a carrier device configured to inject the device-identity information into the secure key request via header enrichment. The system may further be caused to retrieve, from a secured key storage, the private key associated with the device-identity information. The system may further be caused to transmit, from the device-identity management system to the user device over a secured network, secure key information based on the private key. In some embodiments, the secure key information includes a private key.

In some embodiments, the device-identity management system is further caused to generate a derivative key based on the retrieved private key. In such embodiments, the device-identity management system may further be caused to transmit the secured key information from the device-identity management system to the service provider device. In such embodiments, the secured key information may include the derivative key.

In some embodiments, the device-identity management system is further caused to generate a session key based on the retrieved private key. In such embodiments, the secure key information may include the session key.

In some embodiments, the device-identity management system is further caused to generate the session key based on the retrieved private key. In such embodiments, the device-identity management system may be further caused to generate an encrypted session key based on the session key. In such embodiments, the secure key information may include the encrypted session key, and the transmission of the secure key information to the user device may cause the user device to transmit the encrypted session key to the service provider device.

In some embodiments, the device-identity management system is further caused to generate a session key based on the retrieved private key. In such embodiments, the device-identity management system may be further caused to generate an encrypted session key based on the session key. In such embodiments, the device-identity management system may be further caused to transmit the encrypted session key from the device-identity management system to the service provider device. In such embodiments, the secure key information may include at least one selected from the group of (1) the session key and (2) the encrypted session key.

In some embodiments, the device-identity management system is further caused to identify a device location associated with the user device. In such embodiments, the device-identity management system may be further caused to generate a dynamic location area based on at least one selected from the group of (1) the user device and (2) the device-identity information. In such embodiments, the device-identity management system may be further caused to determine the device location is within the dynamic location area. In such embodiments, the device-identity management system may be caused to retrieve the private key in response to the determination that the device location is within the dynamic location area.

In some embodiments, the device-identity management system is further caused to identify a device location associated with the user device. In such embodiments, the device-identity management system may be further caused to determine a static location area based on at least one selected from the group of (1) the user device and (2) the device-identity information. In such embodiments, the device-identity management system may be further caused to determine the device location is within the static location area. In such embodiments, the device-identity management system is caused to retrieve the private key in response to the determination that the device location is within the static location area.

In some embodiments, the device-identity management system is further caused to identify a device location associated with the user device. In such embodiments, the device-identity management system may be further caused to retrieve a historical device location set based on at least one selected from the group of (1) the user device and (2) the device-identity information. In such embodiments, the device-identity management system may be further caused to determine, using a trained machine learning model, the device location is not fraudulent based on the historical device location set. In such embodiments, the device-identity management system may be caused to retrieve the private key in response to the determination that the device location is within the static location area.

In some embodiments, the device-identity management system is further caused to determine a subscriber identity module history associated with the device-identity information. In some embodiments, the device-identity management system is further caused to verify the subscriber identity module history satisfies a minimum module age threshold.

In some embodiments, the device-identity management system is further caused to cause the user device to store the secure key information in an operating system supported storage associated with the user device. In some embodiments, the device-identity management system is further caused to cause the user device to establish secured communication with the service provider device using the secure key information.

In some embodiments, a computer-implemented method may be provided for managing storage of certificate information in a manner associated with device-identity information and facilitating secure communication between a user device and a service provider device. The method includes receiving, at a device-identity management system, from the user device, a secure key request indicative of access by the user device of a link configured by the service provider device in response to the service provider device receiving a request for services from the user device, the secure key request comprising at least device-identity information, the secure key request transmitted over a carrier network comprising at least a carrier device configured to inject the device-identity information in the secure key request via header enrichment. The method further includes retrieving, from a secured key storage, the private key associated with the device-identity information. The method further includes transmitting, from the device-identity management system to the user device over a secured network, secure key information based on the private key. In some embodiments, the secure key information includes the private key. In some embodiments, the secure key information may include the private key.

In some embodiments, the method further includes generating a derivative key based on the retrieved private key, and transmitting the secured key information from the device-identity management system to the service provider device. In such embodiments, the secured key information may include the derivative key.

In some embodiments, the method further includes generating a session key based on the retrieved private key. In such embodiments, the secure key information may include the session key.

In some embodiments, the method further includes generating a session key based on the retrieved private key. In such embodiments, the method may further include generating an encrypted session key based on the session key. In such embodiments, the secure key information may include the encrypted session key, and transmitting the secure key information comprising the encrypted secret key causes the user device to transmit the encrypted session key to the service provider device.

In some embodiments, the method further includes generating a session key based on the retrieved private key. In such embodiments, the method may further include generating an encrypted session key based on the session key. In such embodiments, the method may further include transmitting the encrypted session key from the device-identity management system to the service provider device. In such embodiments, the secure key information may include at least one selected from the group of (1) the session key and (2) the encrypted session key

In some embodiments, the method further includes identifying a device location associated with the user device, generating a dynamic location area based on at least one selected from the group of (1) the user device and (2) the device-identity information, and determining the device location is within the dynamic location area. In some embodiments, retrieving the private key is in response to the determination that the device location is within the dynamic location area.

In some embodiments, the method further includes identifying a device location associated with the user device, determining a static location area based on at least one selected from the group of (1) the user device and (2) the device-identity information, and determining the device location is within the static location area. In some embodiments, retrieving the private key is in response to the determination that the device location is within the static location area.

In some embodiments, the method further includes identifying a device location associated with the user device, retrieving a historical device location set based on at least one selected from the group of (1) the user device and (2) the device-identity information, and determining, using a trained machine learning model, the device location is not fraudulent based on the historical device location set. In some embodiments, retrieving the private key is in response to the determination that the device location is within the static location area.

In some embodiments, the method further includes determining a subscriber identity module history associated with the device-identity information, and verifying the subscriber identity module history satisfies a minimum module age threshold.

In some embodiments, the method further includes causing the user device to store the secure key information in an operating system supported storage associated with the user device.

In some embodiments, the method further includes causing the user device to establish secured communication with the service provider device using the secure key information.

In some embodiments, a computer program product may be provided to manage storage of certificate information in a manner associated with device-identity information and facilitate secure communication between a user device and a service provider device. The computer program product includes at least one non-transitory computer readable storage medium having computer program instructions stored therein, the computer program instructions configured to, when executed by a processor, cause the processor to receive, at a device-identity management system, from the user device, a secure key request indicative of access by the user device of a link configured by the service provider device in response to the service provider device receiving a request for services from the user device, the secure key request comprising at least device-identity information, the secure key request transmitted over a carrier network comprising at least a carrier device configured to inject the device-identity information in the secure key request via header enrichment. The computer program instructions are further configured to cause the processor to retrieve, from a secured key storage, the private key associated with the device-identity information. The computer program instructions are further configured to cause the processor to transmit, from the device-identity management system to the user device over a secured network, secure key information based on the private key.

In some embodiments, the computer program instructions are further configured to cause the processor to generate a derivative key based on the retrieved private key, and transmit the secured key information from the device-identity management system to the service provider device. In such embodiments, the secured key information may include the derivative key.

In some embodiments, the computer program instructions are further configured to cause the processor to generate a session key based on the retrieved private key. In such embodiments, the secure key information may include the session key.

In some embodiments, the computer program instructions are further configured to cause the processor to generate a session key based on the retrieved private key, and generate an encrypted session key based on the session key. In such embodiments, the secure key information may include the encrypted session key, and the transmission of the secure key information including the encrypted secret key causes the user device to transmit the encrypted session key to the service provider device.

In some embodiments, the computer program instructions are further configured to cause the processor to generate a session key based on the retrieved private key, generate an encrypted session key based on the session key, and transmit the encrypted session key from the device-identity management system to the service provider device. In such embodiments, the secure key information may include at least one selected from the group of (1) the session key and (2) the encrypted session key.

In some embodiments, the computer program instructions are further configured to cause the processor to identify a device location associated with the user device, generate a dynamic location area based on at least one selected from the group of (1) the user device and (2) the device-identity information, and determine the device location is within the dynamic location area. In such embodiments, the processor may be caused to retrieve the private key in response to the determination that the device location is within the dynamic location area.

In some embodiments, the computer program instructions are further configured to cause the processor to identify a device location associated with the user device, determine a static location area based on at least one selected from the group of (1) the user device and (2) the device-identity information, and determine the device location is within the static location area. In such embodiments, the processor may be caused to retrieve the private key in response to the determination that the device location is within the static location area.

In some embodiments, the computer program instructions are further configured to cause the processor to identify a device location associated with the user device, retrieve a historical device location set based on at least one selected from the group of (1) the user device and (2) the device-identity information, and determine, using a trained machine learning model, the device location is not fraudulent based on the historical device location set. In such embodiments, the processor may be caused to retrieve the private key in response to the determination that the device location is within the static location area.

In some embodiments, the computer program instructions are further configured to cause the processor to determine a subscriber identity module history associated with the device-identity information, and verify the subscriber identity module history satisfies a minimum module age threshold.

In some embodiments, the computer program instructions are further configured to cause the processor to cause the user device to store the secure key information in an operating system supported storage associated with the user device.

In some embodiments, the computer program instructions are further configured to cause the processor to cause the user device to establish secured communication with the service provider device using the secure key information.

In some embodiments, an apparatus is provided for managing storage of certificate information in a manner associated with device-identity information and facilitating secure communication between a user device and a service provider device, the apparatus comprising means for receiving, at a device-identity management system, from the user device, a secure key request indicative of access by the user device of a link configured by the service provider device in response to the service provider device receiving a request for services from the user device, the secure key request comprising at least device-identity information, the secure key request transmitted over a carrier network comprising at least a carrier device configured to inject the device-identity information in the secure key request via header enrichment. The apparatus further includes means for retrieving, from a secured key storage, the private key associated with the device-identity information. The apparatus further includes means for transmitting, from the device-identity management system to the user device over a secured network, secure key information based on the private key.

In some embodiments, the apparatus further includes means for generating a derivative key based on the retrieved private key, and means for transmitting the secured key information from the device-identity management system to the service provider device. In such embodiments, the secured key information may include the derivative key.

In some embodiments, the apparatus further includes means for generating a session key based on the retrieved private key. In such embodiments, the secure key information may include the session key.

In some embodiments, the apparatus further includes means for generating a session key based on the retrieved private key, and means for generating an encrypted session key based on the session key. In such embodiments, the secure key information may include the encrypted session key, and wherein transmitting the secure key information comprising the encrypted secret key causes the user device to transmit the encrypted session key to the service provider device.

In some embodiments, the apparatus further includes means for generating a session key based on the retrieved private key, means for generating an encrypted session key based on the session key, and means for transmitting the encrypted session key from the device-identity management system to the service provider device. In such embodiments, the secure key information may include at least one selected from the group of (1) the session key and (2) the encrypted session key.

In some embodiments, the apparatus further includes means for identifying a device location associated with the user device, means for generating a dynamic location area based on at least one selected from the group of (1) the user device and (2) the device-identity information, and means for determining the device location is within the dynamic location area. In such embodiments, retrieving the private key may be in response to the determination that the device location is within the dynamic location area.

In some embodiments, the apparatus further includes means for identifying a device location associated with the user device, means for determining a static location area based on at least one selected from the group of (1) the user device and (2) the device-identity information, and means for determining the device location is within the static location area. In such embodiments, retrieving the private key may be in response to the determination that the device location is within the static location area.

In some embodiments, the apparatus further includes means for identifying a device location associated with the user device, means for retrieving a historical device location set based on at least one selected from the group of (1) the user device and (2) the device-identity information, and means for determining, using a trained machine learning model, the device location is not fraudulent based on the historical device location set. In such embodiments, retrieving the private key may be in response to the determination that the device location is within the static location area.

In some embodiments, the apparatus further includes means for determining a subscriber identity module history associated with the device-identity information, and means for verifying the subscriber identity module history satisfies a minimum module age threshold.

In some embodiments, the apparatus further includes means for causing the user device to store the secure key information in an operating system supported storage associated with the user device.

In some embodiments, the apparatus further includes means for causing the user device to establish secured communication with the service provider device using the secure key information.

In some embodiments of the system, method, computer program product, or apparatus, the device-identity information includes (1) a mobile phone number in a plain-text format, or (2) a mobile phone number in a hashed format. In some embodiments, the carrier network is an out-of-band network with respect to the secured network.

### BRIEF DESCRIPTION OF THE DRAWINGS

Having thus described embodiments of the disclosure in general terms, reference will now be made to the accompanying drawings, which are not necessarily drawn to scale, and wherein:

FIG. 1 illustrates a block diagram of a system that may be specially configured, within which embodiments of the present disclosure may operate;

FIG. 2 illustrates a block diagram of an example apparatus that may be specially configured in accordance with an example embodiment of the present disclosure;

FIG. 3A illustrates a data flow diagram depicting example operations in accordance with an example embodiment of the present disclosure;

FIG. 3B illustrates another data flow diagram depicting example operations in accordance with an example embodiment of the present disclosure;

FIG. 4 illustrates a flowchart depicting various operations performed in an example process for transmitting secure key information to a user device based on received device-identity information, in accordance with an example embodiment of the present disclosure;

FIG. 5A illustrates a flowchart depicting various operations performed in an example process for device location verification process, in accordance with an example embodiment of the present disclosure;

FIG. 5B illustrates a flowchart depicting various operations performed in another example process for device location verification process, in accordance with an example embodiment of the present disclosure; and

FIG. 6 illustrates a flowchart depicting various operations performed in an example SIM age verification process, in accordance with an example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

### Overview

PKI certificates facilitate verification of user/user device identity by leveraging cryptographic signatures. Messages, requests, data, and other information transmitted over a network may be “signed” by a sender with a secret cryptographic key, creating an encrypted data message. The encryption algorithm used to sign the message is often designed such that the encrypted data message may then be decrypted by a second key corresponding to the sender, and only by that second key. If the recipient obtains the second key associated with a particular sender (for example, via a certificate) and successfully decrypts the encrypted data using the second key, the recipient knows with certainty that the sender is truly who they claim to be, as they would not have been able to create the encrypted message without controlling the secret cryptographic key corresponding to the second key.

The secret key may be a private key, and the second key may be a public key. The private key remains controlled and secret by the entity to be verified (e.g., the sender of a message). The private key forms a pair with a public key, such that messages signed using the private key may only be decrypted using the public key. The public key may be distributed to a recipient device such that the recipient may use the public key to verify the identity associated with a sender of incoming messages, in other words to confirm the message sender truly is who they claim to be. To facilitate easy transmission and storage, the public key may be stored in a certificate, which may contain other information such as information associated with the certificate holder, information associated with the entity for which the certificate is verifying, a signature chain used to verify the entities issuing the certificate, and the like.

Service providers devices typically store, or otherwise have access to, their own certificates, which that may be used to verify to user devices contacting the service provider device that the service provider device is who they claim to be. However, user devices typically do not have certificates associated with them, and thus may not utilize the same verification methods in providing reciprocal confirmation to the service provider device that the user device is who they claim to be.

Embodiments of the present disclosure create and manage certificate information linked/associated with device-identity information that serves as a proxy for identifying the user/user device, such as a mobile phone number. The certificate information may include public certificates to be distributed to service provider devices and/or other third-party devices, for example certificates including a public key, certificate chain/certificate verification information, or the like. The certificate information may also include a private key and/or corresponding secure key information, such as derivative keys, session keys, encrypted session keys, or the like. The private key, secure key information, and/or other secret information, may be stored in a secure environment, for example a secure key storage, while public certificates/information may be stored in a user certificate repository, which may be equally as secure or less secure than the secure key storage.

The certificate information (e.g., at least the private key and public key) for a given user identity may be stored in a manner associated with device-identity information, such that the certificate information is retrievable using the device-identity information. The device-identity information is received via a highly accurate transmission process, such that the device-identity management system receiving the device-identity information can confidently assume the device-identity information received is associated with a particular user device. For example, Applicants have identified that such device-identity information functions as a proxy for the identity of the device holder. For example, mobile phones have become as ubiquitous as a wallet or purse. Mobile phones are typically kept in close proximity to the user and kept in control of that user. In the event of loss or theft, the mobile phone is typically protected by a numeric passcode, a pattern passcode, a fingerprint or other biometric characteristic of the user, or the like. While the user may change to a new phone (e.g., user device) in the event of a loss or theft, the user retains their phone number. The certainty between the mobile phone number and a user identity associated with the user device relies on the security built into the subscriber identity module (SIM). The SIM is highly secure, as it is used by the mobile phone carrier to positively identify the user of a mobile device for billing purposes. When a user replaces a SIM for a device, such as a SIM card, the user often still retains their mobile phone number.

The device-identity information may be received via a secure process for ensuring the received information is associated with the requesting user device. For example, in some embodiments, a device-identity management system receives device-identity information, such as a mobile phone number, for a user device over a carrier network via header enrichment. In particular, a header enrichment process may include, for example, packet headers “injected” by a trusted party, such as a carrier network provider or through a login process, in which packet headers comprise device identification information. For example, in some embodiments, one or more network providers (such as a mobile carrier) may inject a phone number associated with a mobile device within packet headers. In this manner, the device-identity management system obtains the device-identity information without user input. Since the mobile phone is likely secured such that only the rightful user of a user device associated with a mobile phone number may access it, a carrier may be sure that when a request is made from a device associated with that mobile phone number, it is truly from the user associated with the mobile phone number. Thus, the mobile phone number functions as device-identity information because it serves as a proxy for the identity of the user.

By generating and/or storing certificate information associated with device-identity information, a device-identity management system that receives a request including device-identity information may be certain that the request is from the user associated with the user device. The device-identity management system may retrieve stored certificate information, and distribute the certificate information, portions thereof, or derivative information based on the certificate information, to the user device and/or a service provider device associated with the request. The device-identity management system may transmit certificate information as needed to establish and facilitate secure communication between the user device and service provider device (or between the user device and another third-party device).

Additionally or alternatively, the device-identity management system may be configured to perform additional security verification processes associated with the device-identity information and/or user device. For example, the device-identity management system may be configured to determine, retrieve, or otherwise identify a subscriber identity module history associated with the device-identity information, such as where the device-identity information includes a mobile phone number. The device-identity management system may determine or extract a SIM age to determine whether the current SIM associated with the device-identity information satisfies a minimum module age threshold. In some embodiments, if the SIM age is less than the minimum module age threshold, an identity event may be rejected due to the lack of trustworthiness associated with the device-identity information. Similarly, the identity event may be approved or accepted if the minimum module age threshold is satisfied.

Additionally or alternatively, the device-identity management system may confirm a device location for the user device is within a device location area associated with the user device. For example, the device location area may be determined based on various historical device locations associated with the user device. Thus, the device-identity management system may be even more confident the user of the user device is who they claim to be, because they are in a geographic area that the user device is commonly located in and/or associated with. In other embodiments, additional security steps may be performed before verifying the trustworthiness of device-identity information, or before accessing a private key (or other certificate information) associated with the device-identity information.

The device-identity management system may transmit certificate information, and/or corresponding secure key information, to a user device and/or a service provider device for use in establishing and maintaining secure communication between the user device and the service provider device. For example, the device-identity management system may transmit, to the user device, a private key associated with the received device-identity information for the user device. The user device may utilize the private key to initiate secure communication with the service provider device, which may have access to the corresponding public key via a certificate retrieved and stored by the service provider device from the device-identity management system in an earlier process. Alternatively or additionally, the device-identity management system may utilize the private key to generate a derivative key based on a key derivation formula, which may be transmitted to the mobile device and/or service provider device. Alternatively or additionally the device-identity management system may initialize secure communication with the service provider device using the private key, where the secure communication is facilitated by a session key generated by the service provider device or device-identity management system. The session key may then be transmitted to the mobile device and/or the service provider device, or encrypted to form an encrypted session key that may then be transmitted to the user device and/or service provider. The encrypted session key may be unencrypted using the public key corresponding to the private key used to encrypt the session key.

The service provider device may obtain and/or store the public key associated with the private key used to verify the user device is who they claim to be. For example, the service provider device may obtain and/or store a certificate for the user device during a prior transaction. Alternatively or additionally, the service provider device may obtain the certificate upon initiation of the secured connection to the user device, such as when the session key, encrypted session key, or connection request is received.

After a user device has received secured key information (e.g., a private key, session key, encrypted session key, or derivative key), the user device can use the secured key information in many ways to establish secure communications with the service provider or to prove the identity of the user device. For example, the secured key information can be used by an application executed on the user device to establish secure communication by performing encrypted communication, for example using TLS or another security protocol. Where the secured key information is a private key or a derivative key, for example, the user device may utilize the received secure key information generate a symmetric key (such as a session key) agreed to by all communicating parties and establish secure communication. The secured key information may then be deleted and the symmetric key may continue to be used to facilitate secure communication. Where the secured key information is a session key or encrypted session key, the secured key information may be used as a symmetric key (or used to generate the symmetric key) to establish and maintain secure communication between the user device and the service provider device.

In some embodiments the secured key information, or derivative information generated using the secured key information, may be stored in an operating system supported storage to facilitate retrieval and/or use by one or more software applications executed on the client device. In some embodiments, the secured key information, or derivative information generated using the secured key information, may be temporarily stored, for example associated with a particular time-out timestamp or for the duration of a particular session. Alternatively, in some embodiments, the secured key information is deleted once a secured connection is established, such that only a session key and/or derivative key is maintained in memory. Deleting the secure key information ensures minimal risk that the secured key information is exposed through hacking, data vulnerabilities, or other mismanagement of the secured key information.

Secured key information can be utilized by the user device, and/or a software application executed on the user device, for a myriad of use cases. For example, the user device may establish secure communication with one or more service provider devices and/or third-party devices using the secured key information. Alternatively or additionally, the user device or an application executed on the user device may use the secured key information to encrypt and/or decrypt secure communications transmitted to a service provider device or other third-party device. Additionally or alternatively, the secure key information may be used to encrypt and/or decrypt data stored on the user device by the software application executed on the user device. For example, a service provider device may control the encryption and/or decryption of data stored on the user device, or the software application executed on the user device may control the encrypting and/or decrypting of data itself.

Managing secure key information using a device-identity management system and secure key requests provides many technical advantages. For example, private keys and/or other secure key information need not be stored by a user device, and therefore cannot be stolen if such a user device is stolen physically or electronically compromised (such as by a hackers). Further, secure key information may only be kept for a length of time required, thus minimizing the opportunity for the secure key information to be misappropriated by a malicious user.

A device-management system may rotate and/or change secure key information such that each key transmitted to a user device only has a short lifespan, which minimizes the opportunity for theft and minimizes the negative effects of a successful key theft. Because a device-identity management system stores the private key(s) associated with a given user, the user never needs to install, handle, or otherwise become a technical expert on cryptographic secure key management and/or storage. Additionally or alternatively, secure key information may be used outside a HTTPS protected tunnel context, and thus can be used for communication applications, end-to-end messaging encryption and/or email encryption, and the like.

Further, the device-identity management system manages private keys and public keys associated with device-identity information, which may link certificate information with a mobile phone number, for example, that is trustworthy through the SIM operating on the GSM or CDMA networks. Additionally, since certificates/certificate information are associated with a device-identity information rather than with a user device itself, the certificates/certificate information are more easily manageable (e.g., to manage installation, expiration, revocation, and the like).

### Definitions

As used herein, the terms “data”, “content”, “information”, and similar terms, may be used interchangeably to refer to data capable of being captured, transmitted, received, displayed, and/or stored in accordance with various example embodiments. Thus, use of any such terms should not be taken to limit the spirit and scope of the disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, and/or the like, sometimes referred to herein as a “network.” Where multiple networks are described, it will be appreciated that each network in the multiple networks may utilize entirely different components, share some components, or share all components.

The term “user device” refers to hardware and/or software that is configured to interact with a service provider device and a device-identity management system. In some embodiments, a user device interacts with a service provider device and/or device-identity management system via one or more networks. User devices may include any known computing devices such as, without limitation, mobile phones, smart phones, tablet computers, laptop computers, wearables, personal computers, enterprise computers, and the like.

In some embodiments, the user device is a mobile phone including a subscriber identity module (“SIM”) card or Universal Integrated Circuit Card (UICC). The SIM card or UICC may store a SIM, Universal Subscriber Identity Module (USIM), Removable User Identity Module (RUIM), or a CDMA Subscriber Identity Module (CSIM), any of which may be a software application or integrated circuitry for example stored on the SIM card or UICC, and may comprise at least a unique serial number (ICCID) or an International Mobile Subscriber Identifier (IMSI), The SIM card may be a mini, micro, nano, virtual, or embedded SIM. The SIM may be associated with a particular mobile phone number.

The term “subscriber identity module history” refers to information that identifies an age associated with the current SIM and/or previous SIM(s) associated with a mobile device. In some embodiments, the subscriber identity module history includes a timestamp associated with a SIM replacement event. Additionally or alternatively, in some embodiments the subscriber identity module history includes a SIM age for the SIM currently in use associated with the mobile phone.

The term “device-identity information” refers to information associated with a user device that functions as a proxy for identification of a user, or user device identification, if received associated with the user device. For example, in an example embodiment, device-identity information is a mobile phone number.

The term “minimum module age threshold” refers to an electronically stored threshold value that a subscriber identity module history must be satisfied for device-identity information associated with a particular mobile phone to be trusted. In some embodiments, for example, a minimum module age threshold is a timestamp associated with a date and/or age, such that a particular SIM age be older than (e.g., exceed) the timestamp to be trusted.

The term “operating system supported storage” refers to software, or a combination of hardware and software, of a user device for securely storing secure key information associated with a particular software application executed on the user device. Secure key information stored in a manner associated with a software application is privately accessible to the software application, but may not be accessible to other software applications executed on the user device. In some embodiments, the operating system supported storage stores secure key information temporarily, such as during a particular access session or until the information times out. In some embodiments, the operating system supported storage stores secure key information with no expiration/time-out.

The term “network” refers to one or more servers, relays, routers, network access points, base stations, and/or the like, capable of transmitting information and/or requests between computing devices. For example, in some embodiments, a network may be a mobile carrier network. In another embodiment, a network may refer to a Wi-Fi network, WLAN, LAN, WAN, or the like.

The term “out-of-band” refers to a network or data channel that is separate from a primary network or data channel. For example, in some embodiments, a carrier network may be out-of-band from an Internet network (such as a Wi-Fi, LAN, or the like).

The term “carrier network” refers to a telecoms network infrastructure provided by a telecoms service provider. In some embodiments, a user device is configured to communicate via a carrier network associated with a telecoms service provider (“carrier”) associated with the user device. For example, in some embodiments, a carrier network is a mobile network associated with a mobile carrier.

The term “secured communication” refers to a state of transmissions between a first device, or system, and a second device, or system, over a network, such that the identity of one of the devices may be validated by the other device, and such that transmissions by a device are encrypted such that they can sufficiently identified associated with the device. In some embodiments, secured communication between two devices is established via Hyper Text Transport Protocol Secure (HTTPS) using a security protocol for encrypting communications. In some embodiments, the security protocol is Transport Layer Security (TLS). In some embodiments, the security protocol uses a private key, derivative key, session key, encrypted session key, or a combination thereof, to establish the secured connection. In some embodiments, secured communications are transmitted over a particular network, which is referred to as a “secured network.”

The terms “carrier header enrichment” or “header enrichment” refer to a process for authenticating a mobile device or an owner of the mobile device via a Direct Autonomous Authentication process, involving a packet header enrichment in which packet headers comprise device identification information, for example, “injected” therein by a trusted party such as a carrier, network provider or through a login process. For example, in some embodiments, a network may inject a mobile phone number associated with a mobile device within packet headers of a transmission, for example a secure key request. In this manner, the device-identity management system may obtain device-identity information associated with a user device and associated with the user of the user device without user input. Application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

The term “device location” refers to an electronic data object or value representing a physical location associated with a user device. Examples of a device location include, but are not limited to, a latitude and longitude coordinate, a global positioning satellite (GPS) coordinate, an address, a zip code, a county, city, state, province, and/or country, or a combination thereof In some embodiments, a user device is associated with a device location when the user device is detected at the device location via location determination means such as GPS.

The term “dynamic location area” refers to an electronic data object representing a geo-fenced area associated with a particular user device that is generated by a device-identity management system. In some embodiments, the dynamic location area is generated based on one or more historical device locations. For example, in some embodiments, the device-identity management system retrieves a historical device location set from one or more repositories and/or third-party devices or systems.

The term “static location area” refers to an electronic data object representing a geo-fenced area associated with a particular user device that is predetermined and/or set associated with the user device. In some embodiments, a static location area is defined based on a fixed radius around one or more historical device locations associated with a user device.

The term “service provider device” refers to a system, apparatus, or other networked device configured to provide a service to a user device via a network. Examples of service providers include, but are not limited to, an online retailer device, software as a service device, e-commerce device, email system, chat system, and the like. In some embodiments, a service provider device is embodied by a server configured to provide services to a user device via a corresponding software application executed on the user device (e.g., a software application native to the user device, a browser application, a command-line application, and the like).

The term “public key” refers to a string, number, or other data value, which is meant to be shared with a third-party for identity verification, for use in identity verification via a public key infrastructure. A public key is used for encrypting an electronic message or transmission and/or to digitally sign electronic messages or transmissions, and for use in decrypting electronic messages and/or transmissions encrypted using a corresponding private key. A public key may be shared with third-party devices, for example in the form of a certificate, for use in verifying the identity of a device possessing the corresponding private key via asymmetric cryptography.

The term “private key” refers to a string, number, or other data value, which is meant to be kept secure only to the device and/or entity to be verified, for use in identity verification via a public key infrastructure. A private key is used to encrypt an electronic message or transmission and/or to digitally sign electronic messages or transmissions, such that devices with access to the corresponding public key can decrypt the messages/transmissions to verify the sender of the message. A private key must be kept secure to prevent third-party devices from

A particular public key and a particular private key form a “key pair.” A trusted certificate authority may generate a key pair associated with a particular device, such that the key pair may be used to verify the identity of the particular device via a public key infrastructure.

The term “derivative key” refers to a cryptographic key generated based on a private key. In some embodiments, a device-identity management system generates a derivative key utilizing a derivative key generation function. The derivative key generation function may utilize the private key, and/or other certificate information.

The term “session key” refers to a symmetric cryptographic key generated associated with a secured connection between two devices/systems. In some embodiments, a session key is generated for facilitating secure communication between a user device and a service provider device. In some embodiments, a device-identity management system generates a session key for a user device associated with device-identity information using a public key or a private key associated with the device-identity information. In some embodiments, a session key is encrypted using a private key associated with device-identity information to generate an “encrypted session key.” An “encrypted session key” may be unencrypted using a public key corresponding to the private key utilized to encrypt the encrypted session key.

The term “secure key information” refers to a public key, private key, session key, encrypted session key, derivative key, or a combination thereof, for use in establishing and/or maintaining a secured connection between a user device and a service provider device.

The term “secure key request” refers to electronic information transmitted to a device-identity management system from a user device, where the electronic information represents a request to receive secure key information retrieved by the device-identity management system. A secure key request includes at least device-identity information associated with the user device injected by a trusted third-party device, which is used to identify and/or retrieve secure key information and/or certificate information stored by the device-identity management system associated with the device-identity information. In some embodiments, a secure key request is transmitted over a carrier network, and includes device-identity information injected from a carrier device in the carrier network using header enrichment.

The term “certificate information” refers to electronically generated information associated with identity verification of a particular device, system, user, or entity. Certificate information includes, or is associated with, at least a public key and a private key. In some embodiments, certificate information includes “certificate validation information,” which refers to electronically managed data/information that uniquely identifies a device and/or entity that generated the certificate information. For example, in some embodiments certificate validation information includes a digital signature that may be used to verify a certificate authority that generated the certificate information, or multiple digital signatures for verifying multiple certificate authorities that generated and/or validated the certificate information up to a trusted certificate authority. Certificate information may be stored in a “certificate” in various certificate formats. For example, a certificate may include certificate information stored in X.509 format.

The term “device-identity management system” refers to hardware and/or software for storing and retrieving certificate information associated with device-identity information. In some embodiments, a device-identity management system includes at least a user certificate repository and a secured key storage. A device-identity management system is configured to communicate with a user device and/or service provider device to store certificate information associated with device-identity information, and transmit identity messages and/or secure key information to facilitate verification by the service provider device of a user identity associated with a user device. In some embodiments, a device-identity management system enables message encryption and/or secure communications between a user device and a service provider device or third-party device by handling one or more secure key request(s). In some embodiments, a device-identity management system is configured to receive a secure key request, retrieve at least a private key based on device-identity information included in the secure key request, and transmit secure key information based on the retrieved private key to the user device and/or service provider device.

The term “user certificate repository” refers to hardware, software, or a combination thereof, for storing a certificate and/or a portion of certificate information. Information is stored in a user certificate repository associated with device-identity information, such that the information may be retrieved using the device-identity information. For example, in some embodiments, a user certificate repository stores at least a public key. In some embodiments, the device-identity information is a phone number received using carrier header enrichment.

The term “secured key storage” refers to software, hardware, or a combination thereof, for that securely stores private keys, session keys, encrypted session keys, derivative keys, or secure key information, associated with a particular certificate or device-identity information. In some embodiments, the secured key storage is configured to generate a private key associated with device-identity information for storage. Security in a certificate environment using the public key infrastructure hinges on the security of keys stored in the secured key storage. A secured key storage may include any module for storing private keys in a highly secure manner. In some embodiments, the secure key storage is embodied by a highly-secure private key storage.

### System Architecture

The methods, apparatuses, systems, and computer program products of the present disclosure may be embodied by any variety of devices. For example, a method, apparatus, system, and computer program product of an example embodiment may be embodied by a fixed computing device, such as a personal computer, computing server, computer workstation, or a combination thereof. Further, an example embodiment may be embodied by any of a variety of mobile terminals, mobile telephones, smartphones, laptop computers, tablet computers, or any combination of the aforementioned devices.

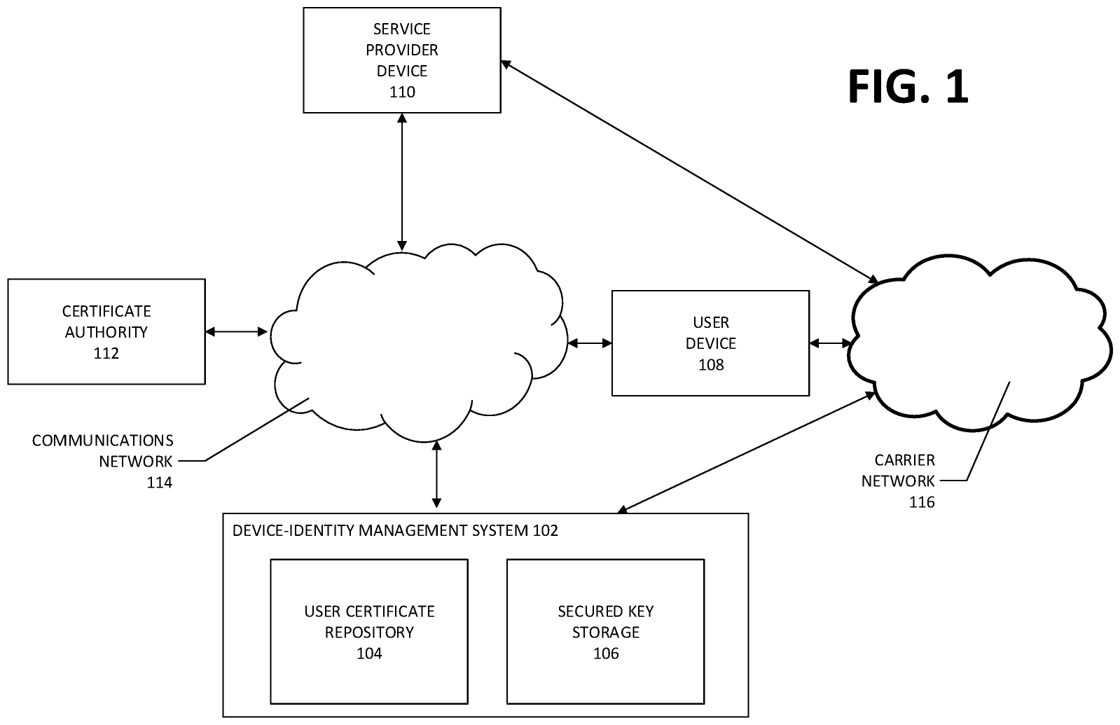

In this regard, FIG. 1 discloses an example computing system in which embodiments of the present invention may operate. FIG. 1 illustrates an overview for a system configured for generating certificate information, managing certificate information associated with device-identity information, and utilizing the certificate information for encrypting data and/or securely communicating between a user device and a service provider device and/or third-party device.

The system includes a device-identity management system 102, user device 108, service provider device 110, and certificate authority 112. The system is similarly associated with communications network 114 and carrier network 116, for communication between the various components as described herein.

The device-identity management system 102 may be one or more computing apparatuses, devices, or the like, configured for managing certificate information (e.g., public certificates or public keys, and private keys) associated with device-identity information as described herein. The device-identity management system 102 includes at least user certificate repository 104, and secured key storage 106. The user certificate repository 104 may be configured to store at least a portion of certificate information, such as public certificate information including at least a public key. The user certificate repository 102 may store the certificate information associated with device-identity information received from the user device 108, such that the certificate information may be retrieved using the device-identity information. For example, the user certificate repository 104 may be queried for certificate information associated with received device-identity information, and result data provided by the user certificate repository 104 may include information stored in a manner associated with the device-identity information. In some embodiments, the user certificate repository 104 may be embodied entirely as software. In other embodiments, the user certificate repository 104 may be embodied by a combination of hardware and software.

Secured key storage 106 may be configured to store at least another portion of certificate information, such as private certificate information. In an example embodiment, the secured key storage 106 is configured to store a private key associated with each certificate. The secured key storage 106 may be configured with additional security measures to prevent physical and/or digital access to unauthorized users. Accordingly, the secured key storage 106 may have improved security over the user certificate repository 104.

Using the structure described, the device-identity management system 102 may be configured to manage storage of certificate information in a manner associated with device-identity information (for example, utilizing the user certificate repository 104 and secured key storage 106). The device-identity management system also may be configured to facilitate secure communication between a user device and a service provider device, for example between the user device 108 and service provider device 110, such as by using the private key stored associated with device-identity information, or using other secure key information.

The certificate authority 112 may be embodied by a remote device and/or system, such as a server, terminal, or the like. The certificate authority 112 may be configured to generate a certificate for a given user, including particular certificate information such as at least a public key and a private key. In some embodiments, certificate authority 112 is configured to receive a request to generate a new certificate from the service provider device 110, user device 108, or device-identity management system 102. For example, one of these devices/systems may transmit a request to generate a new certificate when the user device 108 has not previously been registered with the device-identity management system 102 (e.g., when the user device 108 is first requesting a service from a service provider device).

The certificate authority 112 may transmit the certificate/certificate information the device-identity management system 102 for storage in a manner associated with received device-identity information. For example, where the device-identity management system 102 receives device-identity information from user device 108 for the first time, the device-identity management system 102 may transmit a request to generate a new certificate to the certificate authority 112. When the device-identity management system 102 may receive a response including at least certificate information, including at least public certificate information including at least a public key, which may be stored in the user certificate repository 104, and private certificate information including at least a private key, which may be stored in the secured key storage 106.

The service provider device 110 may be one or more computing devices operated by a third-party entity, and be configured to provide one or more services. For example, the service provider device 110 may be one or more remote servers configured to provide a particular product, offering, service, software, or the like. For example, the service provider device 110 may be associated with an email service, messaging service, ecommerce service, or the like. A service provider device 110 may be associated with a service provider repository for storing information associated with users/user devices accessing the service provider device 110. For example, in some embodiments, the service provider device may be configured to store certificate information, session keys and/or other access information, or the like associated with the user device 108.

The user device 108 may be associated with any number of known computing devices. For example, the user device 108 may be embodied by a mobile phone, smart phone, tablet, laptop, personal computer, wearable device, set-top box, internet-of-things enabled device (IoT device), or the like. The user device 108 may be associated with a particular user that owns, controls, or otherwise utilizes the user device 108.

The service provider device 110, user device 108, and device-identity management system 102 may each communicate via the communications network 114. Additionally or alternatively, in some embodiments, the certificate authority 112 may communicate with each of the components via the communications network 114. In other embodiments, the certificate authority 112 may communicate only with the service provider device 110 and/or the device-identity management system 102. The communications network 114 may be embodied by one of various network implementations (Internet, LAN, and the like) and include various known network components.

The user device 108 may communicate with the service provider device over the communications network 114 to request, and receive, electronic services offered associated with the service provider device 110. The user device 108 may request and receive services from the service provider device 110 via the communications network 114. For example, a user may access or execute a software application associated with the service provider device 110 via the user device 108, which requests services from the service provider device 110.

The service provider device 110 may communicate with the device-identity management system 102 to verify the identity of the user associated with the user device 108, and/or to establish secure communication with the user device 108. The service provider device 110 may, for example, receive a certificate/certificate information associated with the user device 108 from the device-identity management system, and may store the received certificate/certificate information. Additionally or alternatively, the service provider device 110 may receive secure key information from the device-identity management system 102 for verifying the identity of the user associated with the user device 108 using the certificate or certificate information, such as by verifying using a public key.

Additionally, the user device 108 is configured to communicate with the device-identity management system 102, and in some embodiments the service provider device 110, over the carrier network 116. The carrier network 116 may be entirely controlled by a carrier entity, and associated with one or more carrier devices for facilitating the flow of information through the carrier network. Transmissions from the user device 108 to the device-identity management system 102 over the carrier network 116 may have device-identity information injected by a carrier device using header enrichment. For example, a carrier device may inject a mobile phone number associated with the user device 108 into a transmission from the user device 108 to the device-identity management system 102 over the carrier network 116. The device-identity management system can trust the device-identity information received via header enrichment was not manipulated by the user device 108, and thus can trust that the device-identity information reflects the identity of the user associated with the user device 108. In some embodiments, the device-identity information may be received along with additional information from the user device 108. In some embodiments, the user device 108 may also communicate with the service provider device 110, or one or more other third-party device(s) via the carrier network 116.

The carrier network 116 may be out-of-band with respect to the communications network 114. The data channels and/or architecture for transmitting communications, requests, or other information via the carrier network 116 may be separate from that of communications network 114. The user device 108 may leverage both networks to prevent device-based and channel-based cyber-attacks.

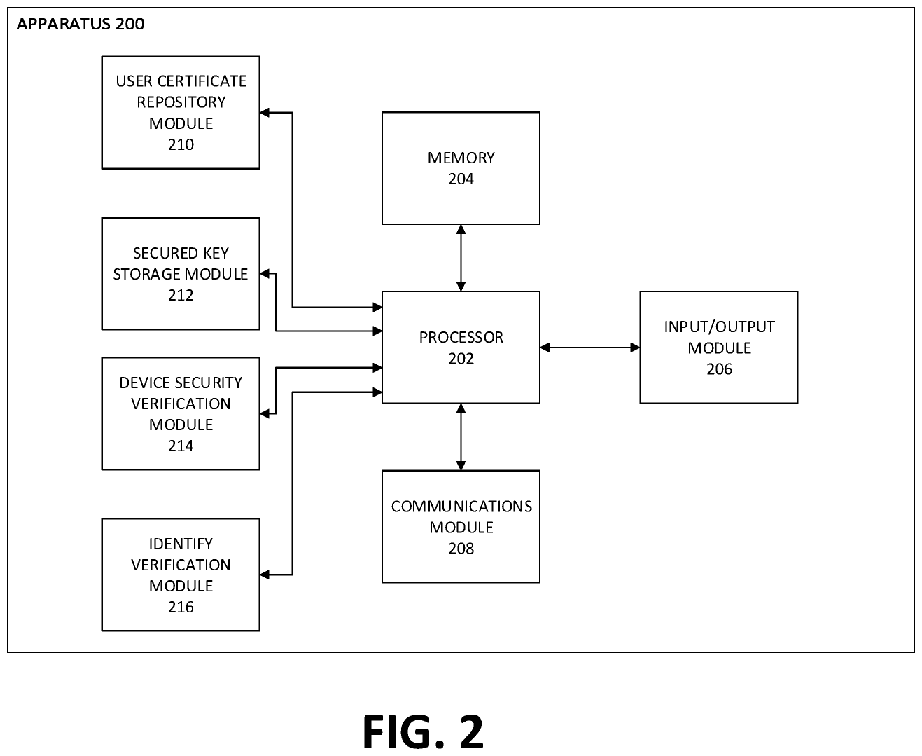

Device-identity management system 102 may be embodied by one or more computing systems, such as apparatus 200 shown in FIG. 2. As illustrated, the apparatus 200 may include a processor 202, a memory 204, an input/output module 206, a communications module 208, a user certificate repository module 210, a secured key storage module 212, a device security verification module 214, and an identity verification module 216. The apparatus 200 may be configured, using means such as the components 202-216, to perform the operations described herein. Although these components 202-216 are described with respect to functional limitations, it should be understood that a particular implementation necessarily include the use of particular hardware. It should also be understood that certain of these components 202-216 may include similar or common hardware. For example, two modules/components/sets of circuitry may both leverage use of the same processor, network interface, storage medium, and/or the like to perform their associated functions, such that duplicate hardware is not required for each module. The use of the terms “module” and “circuitry” as used herein with respect to the components of the apparatus 200 should therefore be understood to include particular hardware configured to perform the functions associated with the particular component as described herein.

Indeed the terms “module” and “circuitry” should be understood broadly to include hardware and, in some embodiments, software and/or firmware for configuring the hardware. For example, in some embodiments, the term “module” may include processing circuitry, storage medium(s), network interface(s), input/output device(s), and the like. In some embodiments, some modules of the apparatus 200 may provide or supplement the functionality of another particular module or multiple modules. For example, the processor 202 may provide processing functionality, the memory 204 may provide storage functionality, the communications module 208 may provide network interface functionality, and the like.

In some embodiments, the processor 202 (and/or co-processor and any other processing module assisting or otherwise associated with the processor) may be in communications with the memory 204 via a bus for passing information among components of the apparatus 200. The memory 204 may be non-transitory and include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus to carry out various functions in accordance with example embodiments of the present invention.

The processor 202 may be enabled in a number of different ways and may, for example, include one or more processing devices configured to perform independently. Additionally or alternatively, the processor may include one or more processors configured in tandem with a bus to enable independent execution of instructions, pipelining, and/or multi-threading. The use of the terms “processor”, “processing module”, and “processing circuitry” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor. Alternatively or additionally, the processor may be configured to execute hard-coded functionality. As such, whether configured by hardware methods, software methods, or a combination thereof, the processor may represent an entity (e.g., physically embodied in the circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output module 206 that may, in turn, be in communication with processor 202 to provide output to the user and, in some embodiments, to receive an indication of a user input. The input/output module 206 may comprise a user interface and may include a display and may comprise a web interface, a mobile application, and/or another user interface, or the like. In some embodiments, the input/output module 206 may also include a keyboard, a mouse, a touch screen, touch areas, soft keys, a microphone, a speaker, or other input/output mechanisms. The processor and/or user interface module comprising the processor may be configured to control one or more functions of one or more user interface elements through computer program instructions (e.g., software and/or firmware) stored on a memory accessible to the processor, such as memory 204 and/or the like.

The communications module 208 may be any means, such as a device, module, and/or circuitry embodied in either hardware or a combination of hardware and software, that is configured to receive and/or transmit data from and/or to another device, module, circuitry, or the like in combination with the apparatus 200. The communications module 208 may include means to communicate with remote devices (such as the user device 108, service provider device 110, and/or certificate authority 112) via one or more networks. In this regard, the communications module 208 may include, for example, one or more network interfaces for enabling communications with one or more wired or wireless communication networks. For example, the communications module 208 may include one or more network interface cards, antennae, buses, switches, routers, modems, and supporting hardware and/or software, or any other device suitable for enabling communications via a network. Additionally or alternatively, the communications module may include a communications interface including circuitry for interacting with the antenna(s) to cause transmission of signals via the antenna(s) or to handle receipt of signals via the antenna(s).

The user certificate repository module 210 includes hardware, software, or a combination thereof, for storing information to a user certificate repository, retrieving information from a user certificate repository, and/or managing information stored in a user certificate repository. Additionally, the user certificate repository module 210 may be configured to generate and configure the user certificate repository for storing said information. The user certificate repository module 210 may be configured to store a portion of certificate information associated with device-identity information, for example public certificate information or at least a public key. The user certificate repository module 210 may be configured to store public keys and/or other certificate information using a permanent storage, for example utilizing memory 204 and/or another associated memory. The user certificate repository module 210 may be configured to store data in a particular data format. For example, the user certificate repository module 210, alone or in conjunction with the processor 202, may be configured to store data in X.509 format. The user certificate repository module 210 may be configured to communicate with one or more other modules of the apparatus to perform one or more functions. For example, the user certificate repository module 210 may receive certificate information associated with device-identity information utilizing, for example, at least the processor 202 and/or communications module 208. In some embodiments, the user certificate repository module 210 may include a separate processor, specially configured field programmable gate array (FPGA), or application specific interface circuit (ASIC) to perform the reception of information to be stored in the user certificate repository. User certificate repository module 210 therefore is configured for implementing at least these planned functions.

The secured key storage module 212 includes hardware, software, or a combination thereof, for storing information to a secured key storage, retrieving information from a secured key storage, and/or managing information stored in a secured key storage. Additionally, the secured key storage module 212 may be configured to generate and configure the secured key storage for storing said information. The secured key storage module 212 may be configured to store a portion of certificate information associated with device-identity information, for example private certificate information or at least a private key. The secured key storage module 212, in some embodiments, includes means for generating and/or storing additional secure key information generated using the private key, such as one or more derivate keys, session keys, encrypted session keys, or the like. The secured key storage module 212 may be associated with hardware physically secured (e.g., located in a safe and/or guarded environment) and/or digitally secure (e.g., sufficiently encrypted and otherwise including access security measures) to prevent unauthorized users from accessing information in the secured key storage. Maintaining security of the secured key storage ensures that the secure key information stored (e.g., private keys and the like) remain a secret known only by the intended user, such that they may continue to be used for trusted identity verification. In some embodiments, the secured key storage module 212 may include a separate processor, specially configured field programmable gate array (FPGA), or application specific interface circuit (ASIC) to perform the reception of information to be stored in the secured key storage. Secured key storage module 212 therefore is configured for implementing at least these planned functions.

The device security verification module 214 includes hardware, software or a combination thereof, for performing one or more security verification processes for confirming the trustworthiness of device-identity information received from a user device. For example, the device security verification module 214 may, together with the processor 202, communications module 208, or the like, retrieve and/or detect one or more device locations associated with a user device. The device security verification module 214 may include hardware configured with software to extract such information from transmissions received from the user device, or retrieve such information from third-party systems and/or service provider devices. Additionally or alternatively, the device security verification module may be configured to retrieve, identify, or otherwise receive device history and/or other information associated with a user device or associated device-identity information transmitted from the user device. For example, in some embodiments, the device security verification module 214 includes hardware configured with software to retrieve a subscriber identity module history associated with received device-identity information, and identify, generate, or retrieve a minimum module age threshold. The device security verification module 214 may be configured to verify the subscriber identity module history satisfies the minimum module age threshold, thus increasing the trustworthiness of the device-identity information received. The device security verification module 214 may include a separate processor, FPGA, or ASIC to perform one or more of the operations described. Device security verification module 214 is therefore implemented using hardware components of the apparatus configured by either hardware, software, or a combination thereof, for implementing these planned functions.

Identity verification module 216 includes means such as hardware, software, or a combination thereof, for receiving device-identity information, generating and/or receiving (for example from a certificate authority) certificate information, identifying and/or transmitting certificate information to external devices (including service provider devices, third-party devices, and/or user devices), transmitting and/or generating secure key information to external devices, and managing the transmission of identity messages to service provider devices and/or third-party systems. In this regard, identity verification module 216 may be in communication with communications module 208 for transmitting and/or receiving various information to/from external devices. Additionally, identity verification module 216 may communicate with user certificate repository module 210, secured key storage module 212, and/or device security verification module 214 for performing one or more of the above operations. The identity verification module 216 may utilize processor 202 in communicating with the various other modules. The identity verification module 216 may, include a separate processor, FPGA, or ASIC to perform one or more operations described. Identity verification module 216 is therefore implemented using hardware components of the apparatus configured by either hardware, software, or a combination thereof, for implementing these planned functions.

It should be appreciated that one or more of the modules 202-216 may be embodied be combined to form one module that performs the function of multiple modules. In some embodiments, for example, each of the modules 210-216 may be embodied entirely in one or several software modules for execution in conjunction with the processor 202 and memory 204.

As will be appreciated, any such computer program instructions and/or other type of code may be loaded onto a computer, processor, or other programmable apparatus' circuitry to produce a machine, such that the computer, processor, or other programmable circuitry that executes the code on the machine creates the means for implementing various functions, including those described herein. For example, in some embodiments, one or more of the modules may be entirely embodied by one or more software modules for performing the functions identified.

As described above and as will be appreciated based on the disclosure, embodiments of the present invention may be configured as methods, mobile devices, backend network devices, and the like. Accordingly, embodiments may comprise various means including entirely hardware, or a combination of hardware and software. Further, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, flask memory, CD-ROMs, optical storage devices, magnetic storage devices, or the like.

Having thus described the system, example data flows, operations, processes, and the like will be described. It should be appreciated that the described data flows, operations, processes, and the like are non-limiting examples, and the system may perform various data flows, operations, or processes in a myriad of ways.

In accordance with some example embodiments, a user device and a service provider device may establish secure communication using the device-identity management system for facilitating secure communication between the devices. In some embodiments, the secure communication between a user device and a service provider device may occur after performing a user registration process, where certificate information is first generated associated with device-identity information and stored by the device-identity management system in a user certificate repository and secured key storage (and in some embodiments stored by the service provider device), and/or performing a user identity event, where the service provider device is provided an identity message from the device-identity management system for verifying the particular identity of associated with a user of a user device by decrypting the identity message with a corresponding public key (e.g., a public key received as part of a certificate/public certificate information). In this manner, embodiments may perform the user registration process and perform the user identity event using a number of exemplary processes as described in application Ser. No. 16/207,907, entitled “IDENTITY VERIFICATION DOCUMENT REQUEST HANDLING UTILIZING A USER CERTIFICATE SYSTEM AND USER IDENTITY DOCUMENT REPOSITORY,” filed on Dec. 3, 2018, which is hereby incorporated by reference in its entirety.

### Example Data Flow in Embodiment System for Retrieving and Using Secure Key Information Via a Device-Identity Management System

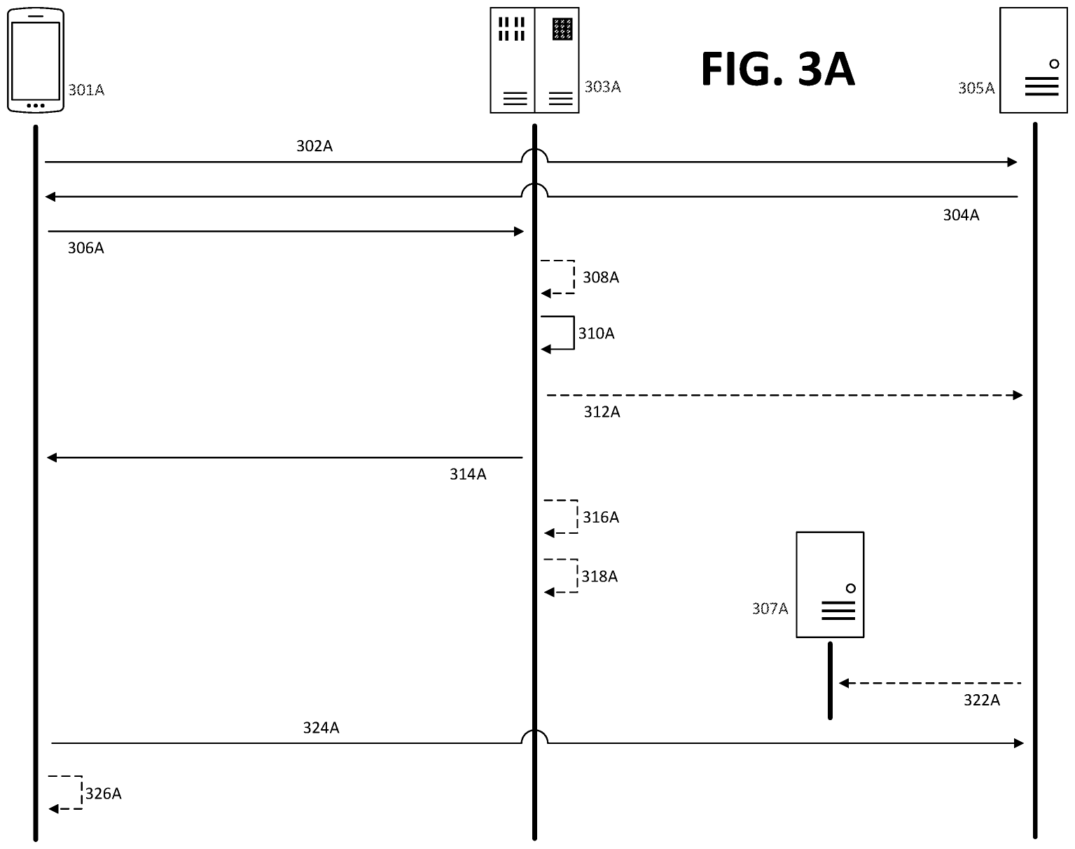

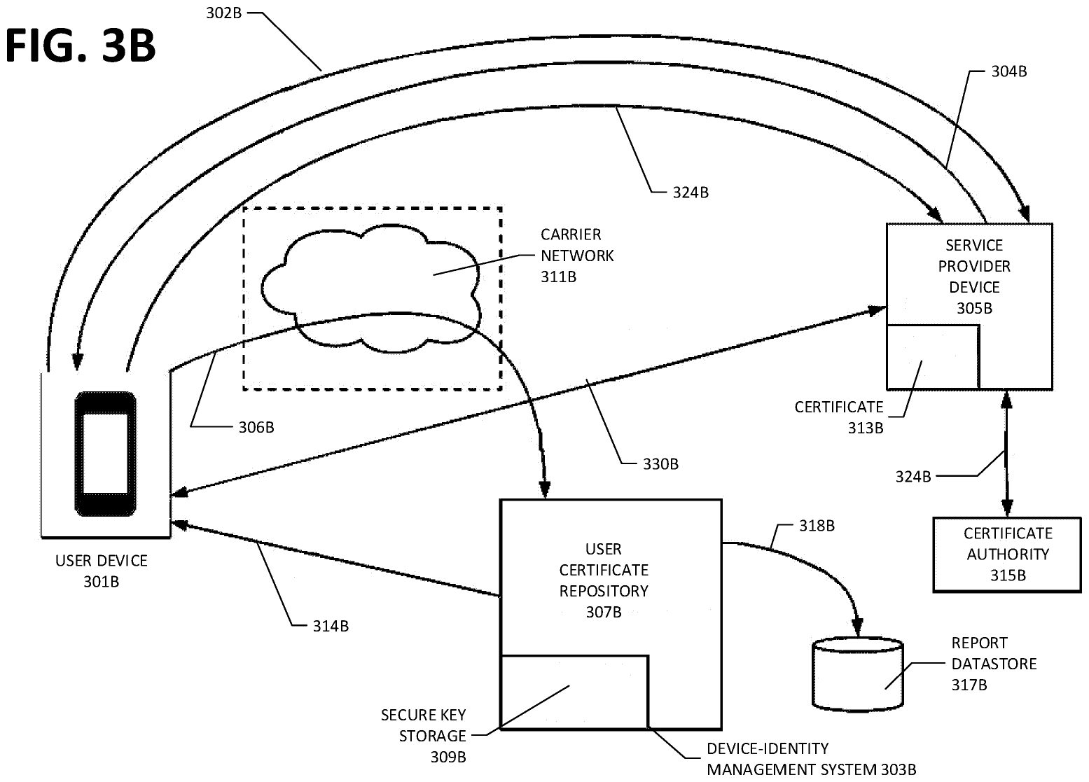

FIG. 3A illustrates a data flow diagram depicting operations for establishing secure communication between a user device and a service provider device via a device-identity management system. Specifically, FIG. 3A illustrates data flow between user device 301A, device-identity management system 303A, and service provider device 305A. By establishing secure communications between the user device 301A and service provider device 305A via the device-identity management system 303A, the service provider device 305A may be confident, based on the veracity of device-identity information and the cryptography associated with a received and/or retrieved public key and corresponding encrypted information (such as session keys or registration handshakes), as to the identity of the user device 301A. Secure communications established using the device-identity management system thus enable the service provider device 305A to verify the identity of the user associated with the user device 301A without information explicitly provided by the user of the user device 301A, thus increasing system security.

At step 302A, the user device 301A transmits a request for services to service provider device 305A. The user device 301A may identify the service provider device 305A based on an IP address, hostname, URL, or the like. The request for services may request access to a particular service, resource, webpage, or the like hosted by the service provider device 305A. The request for services may include at least a device identifier that enables the service provider device 305A to uniquely identify the user device 301A, for example an IP address, IMEI, MEID, or the like. Additionally, in some embodiments, the request for services may include user authentication credentials for additional security.

At step 304A, the service provider device 305A may configure a link for transmitting a secure key request to the device-identity management system 303A, and transmit or otherwise provide the link to the user device 301A. The link may be configured in various ways to, at step 306A, cause the user device to transmit a secure key request from the user device 301A to device-identity management system 303A. The user device 301A may be caused to automatically access the link and thus transmit the secure key request to the device-identity management system 303A, for example using one or more redirects. Alternatively, the link may be configured to cause the user device 301A to transmit the secure key request to the device-identity management system 303A in response to user engagement with the link. For example, the link may be rendered to the user via a display associated with the user device 301A, and configured to receive user engagement (e.g., a tap, a click, voice command, or the like).

At step 306A, the user device 301A may access the device-identity management system 303A by transmitting a secure key request via the link provided by the service provider device 305A. The secure key request may be indicative of access by the user device of a link configured by the service provider device in response to the service provider device receiving a request for services from the user device. To access the device-identity management system 303A, the user device 301A may transmit the secure key request including at least information for identifying the user device 301A and/or the service provider 305A to the device-identity management system 303A. In some embodiments, the user device 301A and/or service provider device 305A may generate and transmit a session identifier to the device-identity management system 303A. The session identifier, and/or device identifier for the user device 301A and/or service provider device 305A may be used by the device-identity management system 303A to identify devices to notify in response to the secure key request and/or provide secure key information (or derivative information) to at a future step.

The user device 301A may transmit all or part of the secure key request to the device-identity management system 303A via a carrier network. The secure key request may have device-identity information injected by a carrier device associated with the carrier network. For example, a mobile carrier controlling a carrier network may facilitate the transmission of the secure key request from the user device 301A, which may be a mobile phone, to the device-identity management system 303A. The mobile carrier, using one or more carrier devices included in the network, may identify, retrieve, extract, or otherwise determine a mobile phone number associated with the user device 301A, and inject the phone number into the transmission of the secure key request using header enrichment. One or more carrier devices may, for example, identify a particular SIM associated with the user device 301A, and identify, extract, retrieve, or otherwise determine the mobile phone number based on the SIM and inject it into the transmission of the secure key request, for example as in a packet header. Because the SIM is highly trustworthy (as the carrier uses the SIM to identify users for purposes of billing), and user device 301A does not have control over inclusion of the mobile phone number in the secure key request, the device-identity management system may be confident that the mobile phone number is legitimately associated with the user device 301A, and thus more likely to be trustworthy.

At step 308A, the device-identity management system 303A may optionally perform one or more additional security verification processes. While the device-identity management system 303A may be confident the device-identity information received associated with the user device 301A is legitimately associated with the user device 301A, the device-identity information may still be obtained via fraudulent means and thus otherwise be untrustworthy. For example, while SIM information is highly secure, they are vulnerable to other weaknesses in a carrier's customer identification protocols. A malicious user may, for example, impersonate a legitimate user to obtain a replacement SIM, and attempt to request services before the legitimate user realizes this has occurred. In some embodiments, device-identity management system 303A may perform the one or more security verification processes to address issues similar to these, and/or to increase the overall security of the system by further verifying the trustworthiness of the device-identity information.

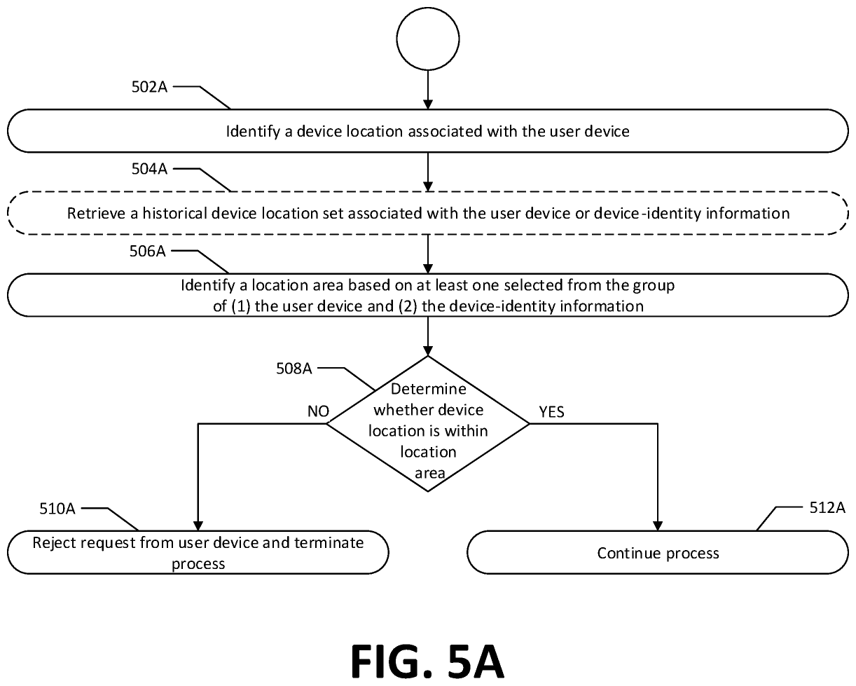

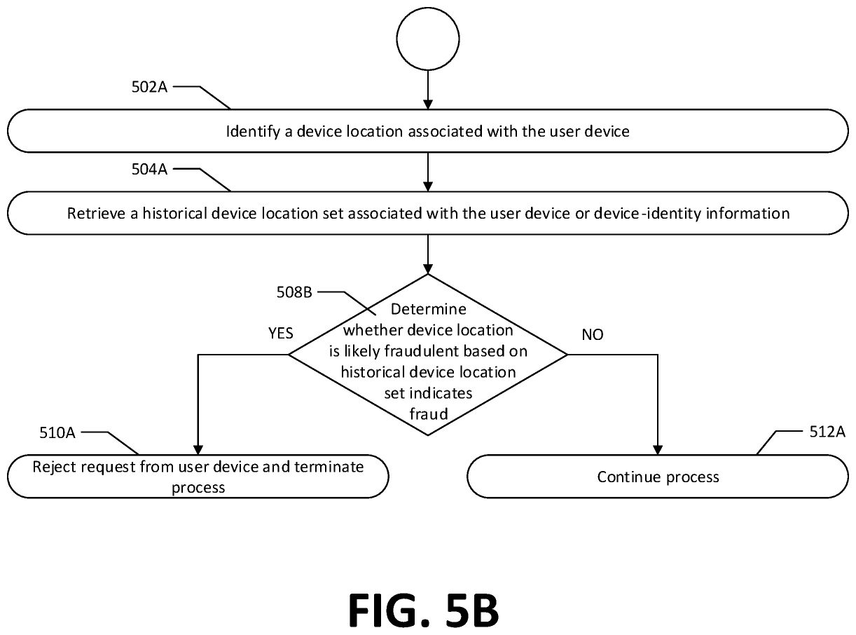

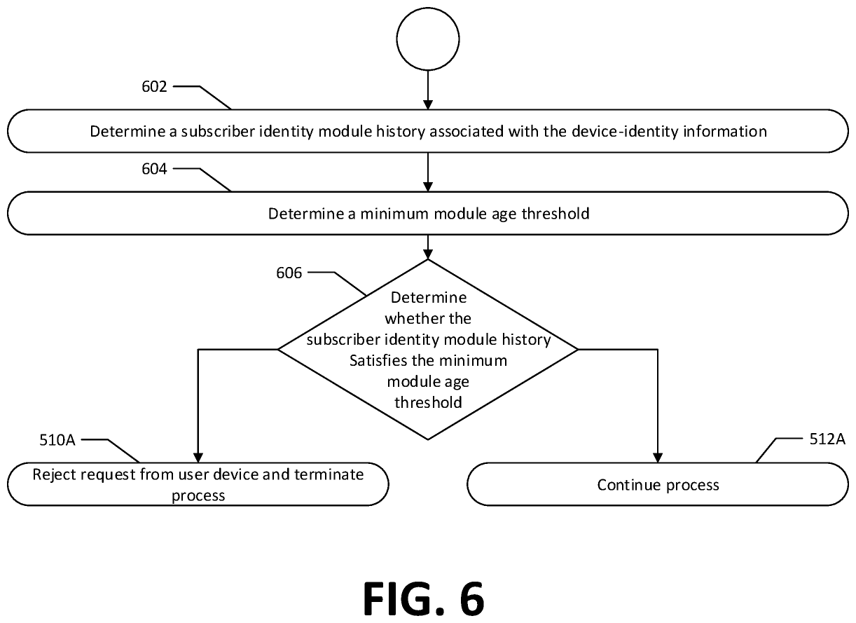

The device-identity information system 303A may perform one, two, or any number of additional processes to further verify the trustworthiness of the device-identity information received. In some embodiments, the device-identity management system 303A may verify a device location associated with the user device 301A, for example via the processes described below with respect to FIGS. 5A and 5B. Additionally or alternatively, the device-identity management system 303A may verify a SIM age associated with the user device 301A, for example via the process described below with respect to FIG. 6. In other embodiments, additional information received in the transmission from the user device 301A may be verified by retrieving and/or otherwise accessing information stored by the device-identity management system 303A or external systems.

At step 310A, the device-identity management system 303A retrieves at least a private key associated with the device-identity information. In some embodiments, the device-identity management system 303A queries a secured key storage, using the device-identity information, for at least the private key. The device-identity management system 303A may have stored the private key information associated with the device-identity information during a user registration process, and thus in response to the query, may receive result data including at least the private key.

In some embodiments, additional or alternative information may be retrieved from the secured key storage. For example, in some embodiments, the device-identity management system may store an earlier generated derivative key, session key, or encrypted session key associated with the device-identity information. The derivative key, session key, or encrypted session key may be temporarily stored, for example associated with a timeout timestamp or until a particular session ends between the user device 301A and the service provider 305A (for example, when a secured connection/communication session is ended due to timeout or a user logout event).

Additionally or alternatively, in some embodiments, the device-identity management system 303A may retrieve certificate information, such as a public key or public certificate, associated with the device-identity information. In some embodiments, the device-identity management system 303A queries a user certificate repository, using the device-identity information, for at least the public key. The device-identity management system 303A may have stored the public key and/or public certificate associated with the device-identity information during a user registration process, and thus in response to the query, may receive result data including at least the public key or public certificate. The public key and/or public certificate may be transmitted to the user device 301A and/or the service provider device 305A for use in decrypting one or more encrypted communications, keys, messages, or other information associated with the device-identity information for verifying a user identity associated with the user device 301A.

At step 314A, the device-identity management system transmits, to the user device 301A, at least secure key information based on the retrieved private key. In various embodiments, the secure key information may embody different types of keys, including the private key itself, a derivative key, a session key, and/or an encrypted session key. In some embodiments, the device-identity management system 303A may additionally transmit the public key and/or public certificate to the user device 301A. By transmitting the public key and/or public certificate to the user device 301A, the device-identity management system 303A may enable and/or cause the user device 301A to further provide the public key and/or public certificate to the service provider device 305A. Additionally or alternatively, the user device 301A may store the public key and/or public certificate, for example to provide to subsequent third-party system(s) and/or service provider device(s) without having to subsequently retrieve the information from the device-identity management system 303A.

The transmission of the secure key information should occur over a secured connection. For example, in some embodiments, the transmission may occur over a network via an established HTTPS connection between the device-identity management system 303A and the user device 301A. The secured connection may be established for secure communication between the user device 301A and the device-identity management system 303A via known protocols, for example using TLS or SSL. In other embodiments, other secured methods may be used to transmit the secure key information to the user device 301A.

In some embodiments, the device-identity management system 303A transmits the private key itself as the secure key information to the user device 301A. The user device 301A may be caused to initiate secure communication based on the private key. For example, the device-identity management system 303A may cause the user device 301A to transmit an encrypted transmission to the service provider device 305A, such that the service provider device 305A may decrypt the encrypted transmission to verify the identity of the user device 301A using a stored or received public key associated with the user device 301A. For example, in some embodiments, the service provider device 305A may be provided the public key as part of a public certificate at an earlier step (e.g., when the user device 301A requests services from the service provider device 305A, or via a transmission from the device-identity management system 303A after receiving the device-identity information or after transmitting the private key to the user device 301A). By receiving an encrypted transmission from the user device 301A, the service provider device 305A may infer that the user device 301 received the private key from the device-identity management system 303A and thus the user identity associated with the user device 301A has been verified based on the device-identity information received by the device-identity management system 303A.

In other embodiments, the secure key information includes derivative key generated by the device-identity management system 303A using the private key. In some embodiments, the device-identity management system 303A generates and transmits as secure key information a session key based on the private key. The device-identity management system 303A may generate a session key associated with the service provider device 305A, which may be used in establishing secure communication between the user device 301A and the service provider device 305A. For example, the device-identity management system 303A may initiate secure communication with the service provider device 305A on behalf of the user device 301A utilizing the private key associated with the received device-identity information (and thus, by proxy, the private key associated with the user of the user device 301A). The secure communication may be facilitated via an HTTPS connection, for example using TLS, SSL, or the like. The session key may then be generated associated with the established secure connection, and forwarded to the user device 301A as part of the secure key information. The user device 301A may then utilize the session key to continue to communicate securely with the service provider device 305A. In some embodiments, the device-identity management system 303A transmits the session key to the service provider device 305A, for example at the optional step 312A. In other embodiments, the service provider device 305A may independently generate the session key, and/or confirm the validity of the session key during a handshake operation when establishing secure communication with the user device 301A.

For example, in some embodiments, the secure key information may, additionally or alternatively, include an encrypted session key. The device-identity management system 303A may first generate or receive the session key as described above. The device-identity management system 303A may generate the encrypted session key by encrypting the session key using the private key retrieved associated with the device-identity information. The encrypted session key may then be transmitted to the user device 301A. The user device 301A may then decrypt the encrypted session key utilizing the corresponding public key (e.g., previously stored as part of a public certificate or received from the device-identity management system 303A along with, or before, the encrypted session key) to reveal the session key for use in establishing a secured connection with the service provider 305A and/or communicating with the service provider 305A via the secured connection. In some embodiments, the user device 301A may additionally transmit the encrypted session key to the service provider device 305A, such that the service provider device 305A may decrypt the encrypted session key using a public key associated with the user device 301A to reveal the session key. The encrypted session key may be transmitted when establishing the secured connection between the user device 301A and the service provider device 305A, for example, such as during a handshake operation when establishing the secured connection via HTTPS. The public key may be transmitted along with the encrypted session key from the user device 301A, or may have been received/stored by the service provider device 305A at an earlier time (such as from the user device 301A along with the request for services).

In other embodiments, the device-identity management system 303A may additionally transmit the encrypted session key, and in some embodiments additionally transmit at least the public key, to the service provider device 305A in addition to transmitting to the user device 301A. For example, the device-identity management system 303A may generate the encrypted session key and transmit at least the encrypted session key to the service provider 305A at optional step 312A. Thus, in some embodiments, the service provider device 301A may not need to rely on a transmission from the user device 301A in obtaining the encrypted session key, and can still verify the encrypted session key is associated with the user device 301A (and by proxy, associated with the user of user device 301A) by successfully decrypting the encrypted session key.

In some embodiments, at optional step 316A, the device-identity management system may generate a key transmission report. The key transmission report may include information regarding the transmission of the secure key information to the user device 301A and/or service provider device 305A. For example, the key transmission report may include a device identifier associated with the user device 301A, a timestamp associated with the transmission of the secured key information to the user device 301A, a device identifier associated with the service provider device 305A, a timestamp associated with the transmission of the secured key information to the service provider device 305A, a digital signature, or a combination thereof. Additionally or alternatively, the key transmission report may include additional metadata and/or information associated with the transmission of the secured key information to the user device 301A and/or service provider 305A.

In some embodiments, at optional step 318A, the device-identity management system may store the key transmission report. In some embodiments, the device-identity management system 303A stores the key transmission report in a report repository, such as one managed by the device-identity management system 303A. In other embodiments, the device-identity management system 303A stores the key transmission report in a ledger accessible to the device-identity management system 303A. In some embodiments, the ledger is a distributed ledger or blockchain, such that the device-identity management system 303A may append the key transmission report to the distributed ledger or blockchain. In some embodiments, the repository, ledger, database, or other mechanism for storing the key transmission report is associated with a third-party device. For example, the device-identity management system 303A may transmit a request to a third-party device that includes the key transmission report for storage by the third-party device.

In some embodiments, the service provider device 305A may verify the public key, or a public certificate, associated with the user device 301A to ensure the public key remains valid and associated with the user device 301A. The service provider device 305A may communicate with a certificate authority device 307A to verify the public key/public certificate remains valid. For example, the service provider device 305A may request the status of a public certificate when the service provider device 305A receives the public key/public certificate. In some embodiments, the service provider may request the status of a public certificate when establishing a new communication session based on the public certificate or corresponding public key.

After receiving the secure key information, the user device 301A may utilize the secure key information for a myriad of use cases, for example at step 324A. In some embodiments, the user device 301A may utilize the secure key information for establishing a secure communication session between one or more software applications executed on the user device 301A and the service provider device 305A. For example, the user device 301A may utilize the secure key information to initialize a HTTPS session with the service provider device 305A. In some embodiments, the secure key information may be utilized by a software application executed on the client device 301A (such as a software application utilized to make the original request for services) to establish and perform encrypted communication, for example using TLS, SSL, or another protocol.

If the secure key information is a private key, it may be used to establish encrypted communication (using TLS, SSL or another protocol) and generate a symmetric encryption key that is agreed to by all communicating devices/systems. In some embodiments, the user device 301A may quickly delete the private key after generating the agreed upon symmetric encryption key, which minimizes opportunities for hackers and/or malicious actors to access the private key via the client device 301A. If the secure key information is a session key (or encrypted session key), it may be used as the symmetric encryption key to establish encrypted communication (using TLS, SSL, or another protocol), or to generate a symmetric encryption key.

Additionally or alternatively, in some embodiments, the secure key information is used by a software application executed on the client device 301A to encrypt and/or decrypt local data stored on the user device 301A by the software application or associated with the software application. In some embodiments, the service provider device 305A may control the data that is encrypted and/or decrypted on the user device 301A. In other embodiments, the encryption/decryption of data stored on the user device 301A may be controlled by the user of the user device 301A, causing the software application executed on the user device 301A to directly contact the device-identity management system without prompting from the service provider device 305A. In this regard, in some embodiments, the user device 301A and software application executed on the user device 301A function, at least in part, as its own service provider device 305A.

In some embodiments, at optional step 326A, the user device 301A may store the symmetric encryption key, secure key information, public key and/or a public certificate including a public key. The device-identity management system 303A may cause the user device 301A to store at least the secure key information. For example, the user device 301A may store the information in an operating system supported storage, such as a keychain storage or the like. The stored information may be retrieved privately by a particular software application executed on the user device 301A. Alternatively, the information may be stored such that it may be retrieved by various software applications executed on the client device 301A. For example, the information may be retrieved a web browser application, email application, chat or messaging application, other synchronous or asynchronous communication application, or the like. In some embodiments, the information may be stored only for a limited time, for example associated with a current session or associated with a particular timeout timestamp. In other embodiments, the information may be stored with no expiration time (e.g., it may persist until deleted by a user of the user device 301A).

FIG. 3B illustrates another data flow diagram depicting operations for establishing secure communication between a user device and a service provider device via a device-identity management system. Specifically, FIG. 3B illustrates an exemplary data flow between user device 301B, device-identity management system 303B, and service provider device 305B.

At step 302B, the user device 301B transmits a request for services to service provider device 305B. The user device 301B may identify the service provider device 305B based on an IP address, hostname, URL, or the like. The request for services may request access to a particular service, resource, webpage, or the like hosted by the service provider device 305B.

The request for services may include at least a device identifier that enables the service provider device 305B to uniquely identify the user device 301B, for example an IP address, IMEI, MEID, or the like. Additionally, in some embodiments, the request for services may include user authentication credentials for additional security.

At step 304B, the service provider device 305B may configure a link for transmitting a secure key request to the device-identity management system 303B, and transmit or otherwise provide the link to the user device 301B. The link may be configured in various ways to, at step 306B, cause the user device to transmit a secure key request from the user device 301B to device-identity management system 303B. The user device 301B may be caused to automatically access the link and thus transmit the secure key request to the device-identity management system 303B, for example using one or more redirects. Alternatively, the link may be configured to cause the user device 301B to transmit the secure key request to the device-identity management system 303B in response to user engagement with the link. For example, the link may be rendered to the user via a display associated with the user device 301B, and configured to receive user engagement (e.g., a tap, a click, voice command, or the like).

Steps 302B and 304B may occur via a communications network (not shown). The communications network may be out-of-band with respect to the carrier network 311B. Specifically, for example, the communications network may be an Internet connected network, such as a Wi-Fi network.

At step 306B, the user device 301B may access the device-identity management system 303B by transmitting a secure key request via the link provided by the service provider device 305B. The secure key request may be indicative of access by the user device of a link configured by the service provider device (at step 304B) in response to the service provider device receiving a request for services from the user device (at step 302B). To access the device-identity management system 303B, the user device 301B may transmit the secure key request including at least information for identifying the user device 301B and/or the service provider 305B to the device-identity management system 303B. In some embodiments, the user device 301B and/or service provider device 305B may generate and transmit a session identifier to the device-identity management system 303B. The session identifier, and/or device identifier for the user device 301B and/or service provider device 305B may be used by the device-identity management system 303B to identify devices to notify in response to the secure key request and/or provide secure key information (or derivative information) to at a future step.

The user device 301B may transmit all or part of the secure key request to the device-identity management system 303B via a carrier network, such as the carrier network 311B. The secure key request may have device-identity information injected by a carrier device associated with the carrier network 311B. For example, a mobile carrier controlling a carrier network may facilitate the transmission of the secure key request from the user device 301B, which may be a mobile phone, to the device-identity management system 303B. The mobile carrier, using one or more carrier devices included in the network, may identify, retrieve, extract, or otherwise determine a mobile phone number associated with the user device 301B, and inject the phone number into the transmission of the secure key request using header enrichment. One or more carrier devices may, for example, identify a particular SIM associated with the user device 301B, and identify, extract, retrieve, or otherwise determine the mobile phone number based on the SIM and inject it into the transmission of the secure key request, for example as in a packet header. Because the SIM is highly trustworthy (as the carrier uses the SIM to identify users for purposes of billing), and user device 301B does not have control over inclusion of the mobile phone number in the secure key request, the device-identity management system 303B may be confident that the mobile phone number is legitimately associated with the user device 301B, and thus more likely to be trustworthy.

The device-identity management system 303B may retrieve at least a private key associated with the received device-identity information. For example, the device-identity management system 303B may retrieve a private key stored in the secure key storage 309B associated with the device-identity information.

Additionally or alternatively, in some embodiments, the device-identity management system 303B may retrieve certificate information, such as a public key or public certificate, associated with the device-identity information. For example, a public certificate may be retrieved from the user certificate repository 307B. In some embodiments, the device-identity management system 303B queries the user certificate repository 307B, using the device-identity information, for the public certificate or at least the public key. The device-identity management system 303B may have stored the public key and/or public certificate associated with the device-identity information during a user registration process, and thus in response to the query, may receive result data including at least the public key or public certificate. The public certificate may be used in decrypting one or more encrypted communications, keys, messages, or other information encrypted using the private key associated with the device-identity information, for verifying a user identity associated with the user device 301B.

At step 314B, the device-identity management system transmits, to the user device 301B, at least secure key information based on the retrieved private key. In various embodiments, the secure key information may embody different types of keys, including the private key itself, a derivative key, a session key, and/or an encrypted session key. In some embodiments, the device-identity management system 303B may additionally transmit the public key and/or public certificate to the user device 301B. By transmitting the public key and/or public certificate to the user device 301B, the device-identity management system 303B may enable and/or cause the user device 301B to further provide the public key and/or public certificate to the service provider device 305B. Additionally or alternatively, the user device 301B may store the public key and/or public certificate, for example to provide to subsequent third-party system(s) and/or service provider device(s) without having to subsequently retrieve the information from the device-identity management system 303B.

The transmission of the secure key information should occur over a secured connection. For example, in some embodiments, the transmission may occur over a communications network via an established HTTPS connection between the device-identity management system 303B and the user device 301B. The secured connection may be established between the user device 301B and the device-identity management system 303B via known protocols, for example using TLS or SSL. In other embodiments, other secured methods may be used to transmit the secure key information to the user device 301B.

In some embodiments, the device-identity management system 303B transmits the private key itself as the secure key information to the user device 301B. The user device 301B may be caused to initiate secure communication based on the private key. For example, the device-identity management system 303B may cause the user device 301B to transmit an encrypted transmission to the service provider device 305B, such that the service provider device 305B may decrypt the encrypted transmission to verify the identity of the user device 301B using a stored or received public key associated with the user device 301B. For example, in some embodiments, the service provider device 305B may be provided the public key as part of a public certificate at an earlier step (e.g., when the user device 301B requests services from the service provider device 305B, or via a transmission from the device-identity management system 303B after receiving the device-identity information or after transmitting the private key to the user device 301B). By receiving an encrypted transmission from the user device 301B, the service provider device 305B may infer that the user device 301B received the private key from the device-identity management system 303B and thus the user identity associated with the user device 301B has been verified based on the device-identity information received by the device-identity management system 303B.

In other embodiments, the secure key information includes derivative key generated by the device-identity management system 303B using the private key. In some embodiments, the device-identity management system 303B generates and transmits as secure key information a session key based on the private key. The device-identity management system 303B may generate a session key associated with the service provider device 305B, which may be used in establishing secure communication between the user device 301B and the service provider device 305B. For example, the device-identity management system 303B may initiate secure communication with the service provider device 305 on behalf of the user device 301B utilizing the private key associated with the received device-identity information (and thus, by proxy, the private key associated with the user of the user device 301B). The secure communication may be facilitated via an HTTPS connection, for example using TLS, SSL, or the like. The session key may then be generated associated with the established secure connection, and forwarded to the user device 301B as part of the secure key information. The user device 301B may then utilize the session key 301B to continue to communicate securely with the service provider device 305B. In some embodiments, the device-identity management system 303B transmits the session key to the service provider device 305, for example at the optional step 312B. In other embodiments, the service provider device 305B may independently generate the session key, and/or confirm the validity of the session key during a handshake operation when establishing secure communication with the user device 301B.

For example, in some embodiments, the secure key information may, additionally or alternatively, include an encrypted session key. The device-identity management system 303B may first generate or receive the session key as described above. The device-identity management system 303B may generate the encrypted session key by encrypting the session key using the private key retrieved associated with the device-identity information. The encrypted session key may then be transmitted to the user device 301B. The user device 301B may then decrypt the encrypted session key utilizing the corresponding public key (e.g., previously stored as part of a public certificate or received from the device-identity management system 303B along with, or before, the encrypted session key) to reveal the session key for use in establishing a secured connection with the service provider 305B and/or communicating with the service provider 305B via the secured connection. In some embodiments, the user device 301B may additionally transmit the encrypted session key to the service provider device 305B, such that the service provider device 305B may decrypt the encrypted session key using a public key associated with the user device 301B to reveal the session key. The encrypted session key may be transmitted when establishing the secured connection between the user device 301B and the service provider device 305B, for example, such as during a handshake operation when establishing the secured connection via HTTPS. The public key may be transmitted along with the encrypted session key from the user device 301B, or may have been received/stored by the service provider device 305B at an earlier time (such as from the user device 301B along with the request for services).

In some embodiments, the device-identity management system may generate a key transmission report. The key transmission report may include information regarding the transmission of the secure key information to the user device 301B and/or service provider device 305B. For example, the key transmission report may include a device identifier associated with the user device 301B, a timestamp associated with the transmission of the secured key information to the user device 301B, a device identifier associated with the service provider device 305B, a timestamp associated with the transmission of the secured key information to the service provider device 305B, a digital signature, or a combination thereof. Additionally or alternatively, the key transmission report may include additional metadata and/or information associated with the transmission of the secured key information to the user device 301B and/or service provider 305B.

In some embodiments, the device-identity management system may store the key transmission report at step 318B. In some embodiments, the device-identity management system 303B stores the key transmission report in a report repository, which may be embodied by report datastore 317B and managed by the device-identity management system 303B. In other embodiments, the device-identity management system 303B stores the key transmission report in a ledger, which may be embodied by report datastore 317B, accessible to the device-identity management system 303B. In some embodiments, the ledger is a distributed ledger or blockchain, which may be embodied by report datastore 317B, such that the device-identity management system 303B may append the key transmission report to the distributed ledger or blockchain. In some embodiments, the repository, ledger, database, or other mechanism for storing the key transmission report is associated with a third-party device. For example, the device-identity management system 303B may transmit a request to a third-party device (not shown) that includes the key transmission report for storage by the third-party device.

After receiving the secure key information, the user device 301B may forward the secure key information, or derivative information thereof, to the service provider device 305B at step 324B. For example, in some embodiments, the user device 301B may transmit use the secure key information to sign a digital message that the service provider device 305B can decrypt using a public certificate to verify a user identity associated with the user device 301B. For example, the service provider device 305B may already have certificate 313B stored in a manner associated with the user device 301B, for example through a previous registration process with the device-identity management system 303B. The service provider 305B may retrieve the certificate 313B for use in verifying a message transmitted from the user device 301B, or in decrypting a forwarded encrypted session key, and to verify the user identity associated with the user device 301B.

In some embodiments, the user device 301B may utilize the secure key information for establishing, maintaining, and utilizing secure communication 330B between the user device 301B and the service provider 305B, for example for a particular session managed by one or more software applications executed on the user device 301B such that the software application may securely communicate with the service provider device 305B. For example, the user device 301B may utilize the secure key information to initialize a HTTPS secure connection for a session with the service provider device 305B, and secure communications 330B may be transmitted via the secure connection. In some embodiments, the secure key information may be utilized by a software application executed on the client device 301B (such as a software application utilized to make the original request for services) to establish and perform encrypted communication, for example using TLS, SSL, or another protocol.

If the secure key information is a private key, it may be used to establish encrypted communication (using TLS, SSL or another protocol) and generate a symmetric encryption key that is agreed to by all communicating devices/systems. The symmetric encryption key may then be used to facilitate secure communications 330B. In some embodiments, the user device 301B may quickly delete the private key after generating the agreed upon symmetric encryption key, which minimizes opportunities for hackers and/or malicious actors to access the private key via the client device 301B. If the secure key information is a session key (or encrypted session key), it may be used as the symmetric encryption key to establish encrypted communication (using TLS, SSL, or another protocol), or to generate a symmetric encryption key.

In some embodiments, before establishing secure communications 330B with the user device 301B, the service provider device 305B may verify the validity of the public certificate 313B associated with the user device 301B to ensure the public key remains valid and associated with the user device 301B. The service provider device 305B may communicate with a certificate authority device 307B to verify the public key/public certificate remains valid. For example, the service provider device 305B may request the status of a public certificate when the service provider device 305B receives the public key/public certificate. In some embodiments, the service provider may request the status of a public certificate when establishing a new communication session based on the public certificate or corresponding public key.

### Example Operations for Transmission of Secure Key Information

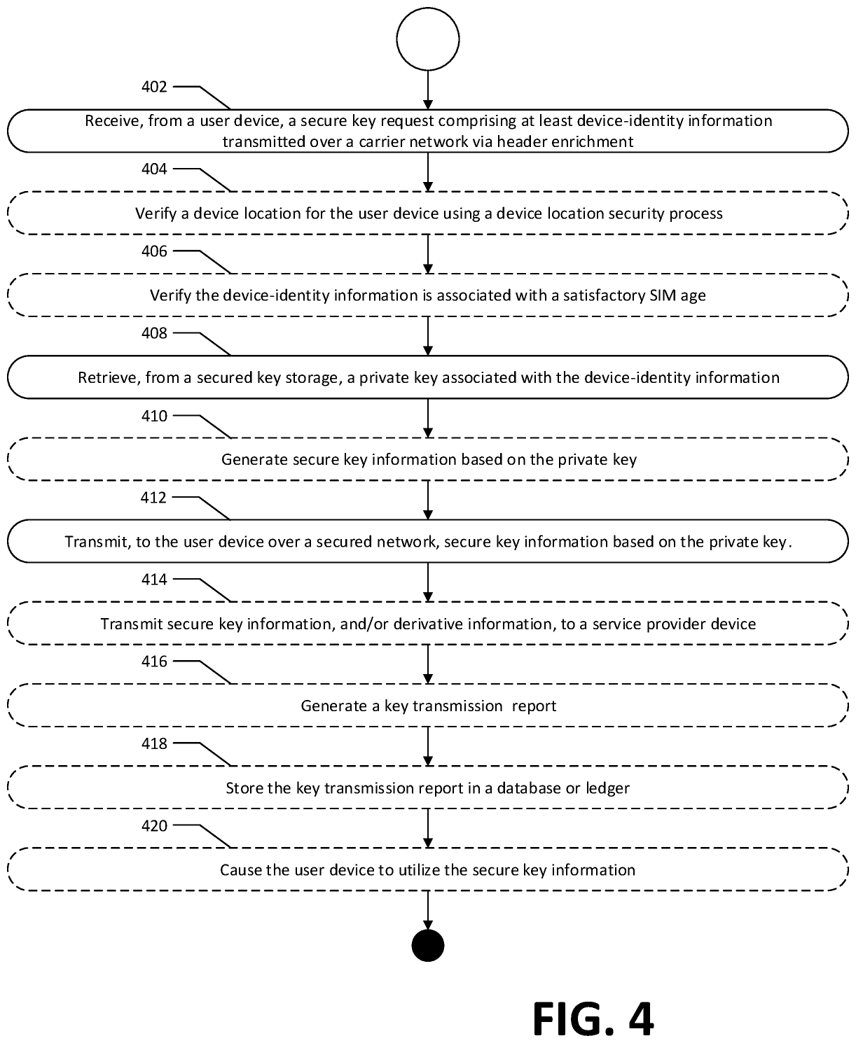

FIGS. 4-6 illustrate example processes in accordance with various embodiments of the present disclosure. It should be appreciated that, in some embodiments, the processes illustrated may include additional, alternative, or a different arrangement of the operations depicted.

FIG. 4 illustrates an example process for transmitting secure key information to a user device based on received device-identity information, for example performed by a device-identity management system embodied by apparatus 200. The operations illustrated may be performed after a user undergoes a registration process with the device-identity management system, and thus certificate information is stored by the device-identity management system associated with device-identity information.

At block 402, the apparatus 200 includes means, such as communications module 208, identity verification module 216, processor 202, and/or the like, configured to receive, from a user device, a secure key request comprising at least device-identity information transmitted over a carrier network via header enrichment. In some embodiments, the secure key request is received in response to the user device accessing, either automatically or via user engagement, a link configured and provided by the service provider device in response to a request for services. The secure key request may additionally include a user device identifier for uniquely identifying a user device that transmitted the request. Additionally, in some embodiments, the secure key request may include a service provider device identifier for uniquely identifying a service provider device that the user device requested services from. In some embodiments, the secure key request may include a session identifier generated by the user device or service provider device, which may be used to notify the user device and/or service provider device that specific retrieved information (e.g., certificate information and/or secure key information) is associated with a specific session between the user device and the service provider device.

The device-identity information serves as a proxy for the identity of the user associated with the user device. For example, the device-identity information may be a mobile phone number associated with a mobile phone. Because mobile phones are ubiquitous, generally kept under control of the rightful user, and associated with a mobile phone number in a secure way for billing purposes (e.g., using a SIM card with appropriate security), the device-identity information may be trusted as associated with the user device transmitting the original response. Additionally, because the carrier injects the device-identity information using header enrichment, the device-identity management system can trust that the user device has not manipulated the device-identity information, further increasing its trustworthiness.

At optional block 404, the apparatus 200 includes means, such as device security verification module 214, communications module 208, processor 202, and/or the like, configured to verify a device location for the user device using a device location security process. For example, in some embodiments, the apparatus 200 may be configured to perform the device location verification process illustrated in FIG. 5A, as described below. In other embodiments, the apparatus 200 may be configured to perform the device location verification process illustrated in FIG. 5B, as described below. In other embodiments, the apparatus 200 may be configured to perform the both the device location verification processes.

At optional block 406, the apparatus 200 includes means, such as device security verification module 214, communications module 208, processor 202, and/or the like, configured to verify the device-identity information is associated with a satisfactory SIM age. In some embodiments, the apparatus 200 may be configured to perform the SIM age verification process illustrated in FIG. 6, as described below.

At block 408, the apparatus 200 includes means, such as secured key storage module 212, processor 202, and/or the like, configured to retrieve, from a secured key storage, a private key associated with the device-identity information. The apparatus 200 may utilize such means to maintain the secured key storage, including various private keys and/or other secure information for registered users such that each private key may be retrieved using corresponding device-identity information. The apparatus 200 may query the secured key storage for a private key associated with the device-identity information, and receive at least the private key as result data in response to the query. In some embodiments, the apparatus 200 may additionally retrieve other secure information stored in the secured key storage, such as one or more derivative keys.

At optional block 410, the apparatus 200 includes means, such as identity verification module 216, communications module 208, processor 202, and/or the like, configured to generate secure key information based on the private key. It should be appreciated that, in some embodiments, the secure key information to be transmitted includes only the private key, and thus block 410 may be skipped. Alternatively, the private key may be utilized to generate a derivative key, session key, or encrypted session key. In some embodiments, a derivate key may be generated using a key derivation function, which may utilize the private key and/or additional information (such as additional information in the public certificate, or additional information stored by the device-identity management system) to generate the derivate key.

In some embodiments, the apparatus 200 may be configured to initiate secure communications with the service provider device using the private key retrieved at block 406, where initiating secure communications includes generating a session key (for example when initiating an HTTPS secure connection for securely communicating). The session key may be a symmetric encryption key agreed upon between the service provider device and the device-identity management system operating on behalf of the user device. Accordingly, the service provider device may trust that the device-identity management system has verified the user device that will receive the session key, and thus can trust the identity of the user device.

In some embodiments, the apparatus 200 may be configured to further encrypt the session key to generate an encrypted session key. The session key may be encrypted using the retrieved private key. Accordingly, the encrypted session key may be decrypted using the corresponding public key, which may be stored by the service provider device from previous steps, or received in a future step. If the service provider device can decrypt the encrypted session key using a public key associated with a particular user device, the service provider device can be confident the device-identity management system has received device-identity information corresponding to the user device, thus verifying by proxy the identity of the user and the user device.

At block 412, the apparatus 200 includes means, such as identity verification module 216, communications module 208, processor 202, and/or the like, configured to transmit, to the user device over a secured network, secure key information based on the private key. The transmission occurs over a network via a secure communication method. In some embodiments, a HTTPS connection may already have been established (e.g., at a previous block, or before the operations illustrated) such that the user device and device-identity management system may communicate with secured, encrypted communications. In other embodiments, the device-identity management system may initiate secure communications, for example using TLS, SSL, or another known protocol, at this block before transmitting the secure key information.

Ensuring the secrecy of the secure key information ensures a malicious user cannot intercept the secure key information and pose as the proper user device associated with the device-identity information received by the device-identity management system. In some embodiments, the transmission is performed over an out-of-band network with respect to the carrier network. Performing the transmission over an out-of-band network may prevent device-based and channel-based cyber-attacks.

At optional block 414, the apparatus 200 includes means, such as identity verification module 216, communications module 208, processor 202, and/or the like, configured to transmit secure key information, and/or derivative information, to a service provider device. The transmission may similarly be performed over a network via a secure communication method. In some embodiments, the transmission may be performed over an out-of-band network.

In some embodiments, the secure key information is transmitted to user device for use in forwarding information to the service provider device. For example, where the secure key information transmitted to the user device includes the private key, the user device may utilize the private key to initialize secure communications with the service provider device. Where the secure key information transmitted to the user device includes a session key, the session key may be forwarded from the user device to the service provider device, and used as a symmetric key or to generate a symmetric encryption key for communicating securely between the user device and the service provider device. Where the secure key information transmitted to the user device includes an encrypted session key, the encrypted symmetric key may be forwarded to the service provider device, which the service provider device may decrypt using a corresponding public key to reveal the session key that may be used as a symmetric encryption key or to generate the symmetric encryption key.

In some embodiments, the session key may be transmitted directly to the service provider device. In such embodiments, the service provider device may utilize the session key as a symmetric encryption key for securely communicating with the user device. In other embodiments, the service provider device may generate the symmetric encryption key using the session key, where the generated symmetric encryption key may then be used for securely communicating with the user device (for example via HTTPS).

Similarly, in some embodiments, an encrypted session key may be transmitted directly to the service provider device. In some embodiments, the service provider device may verify the encrypted session key is associated with the user device by decrypting the encrypted session key using a public key associated with the user device. The public key may be stored, for example as part of a public certificate, associated with the user device and/or a user profile. In some embodiments, the service provider device may retrieve the secure key information from a device-identity management system using a session identifier stored in a manner associated with the user device, for example in response to a request for services earlier received from the user device.

By transmitting secure key information, such as a derivative key, session key, or encrypted session key to directly to the service provider device, the service provider device does not need to rely on receiving the secure key information through the user device. The service provider device may know with greater certainty that the information provided directly from the apparatus 200, for example embodying a device-identity management system, is trustworthy associated with a particular user device.

At optional block 416, the apparatus 200 includes means, such as identity verification module 216, secured key storage module 212, user certificate repository module 210, processor 202, and/or the like, configured to generate a key transmission report. The key transmission report may include all information for summarizing the transmission to the user device and/or the transmission to the service provider device. For example, the key transmission report may include a device identifier associated with the user device, a timestamp associated with the transmission of the secured key information, a device identifier associated with the service provider device, a timestamp associated with the transmission of the secure key information to the service provider device, a digital signature, or a combination thereof. Additionally or alternatively, the key transmission report may include additional metadata and/or information associated with the transmission of the secure key information to the user device and/or the service provider device.

At optional block 418, the apparatus 200 includes means, such as identity verification module 216, communications module 208, processor 202, and/or the like, configured to store the key transmission report in a database or ledger. In some embodiments, the key transmission report is stored in a report repository managed by the apparatus 200. In other embodiments, the device-identity management system 303 stores the key transmission report in a ledger accessible to the apparatus 200. In some embodiments, the ledger is a distributed ledger or blockchain, such that the apparatus 200 may append the key transmission report to the distributed ledger or blockchain. In some embodiments, the repository, ledger, database, or other mechanism for storing the key transmission report is associated with a third-party device. For example, the apparatus 200 may transmit a request to a third-party device that includes the key transmission report for storage by the third-party device.

At optional block 420, the apparatus 200 includes means, such as the identity verification module 216, communications module 208, processor 202, and/or the like, to cause the user device to utilize the secure key information. In some embodiments, for example, the transmission to the user device may cause the user device to perform one or more actions via a software application executing on the user device. The software application may be caused to perform the actions automatically, for example when the secure key information is received in response to the original key request.

In some embodiments, the user device may be caused to use the secure key information to establish secure communications with a service provider device via a software application executed on the client device.

Additionally or alternatively, the user device may be caused to establish and perform encrypted communication using the secure key information. For example, if the secured key information is a private key, the user device may be configured to establish secured communication using one or more encryption protocols (e.g., TLS, SSL, or the like). The user device may be caused to generate a symmetric encryption key, and thus may delete the private key. The user device may be caused to use a session key or an encrypted session key (1) as a symmetric encryption key, or (2) to generate a symmetric encryption key, for enabling secure communications using an encryption protocol.

Additionally or alternatively, the user device may be caused to store the secure key information and/or derivative information generated based on the secure key information. In some embodiments, the secure key information and/or derivative key information may be stored in an operating system supported storage. The secure key information and/or derivative key information may be stored such that (1) only a receiving software application executed on the client device may access the stored information, or (2) multiple software applications may access the stored information. In some embodiments, the information is stored in a manner associated with particular session, such that the information is deleted after the session ends. In other embodiments, the information is stored in a manner associated with a particular timeout timestamp, such that the information is deleted after the timeout timestamp. In other embodiments, the information may be stored in a manner associated with no expiration time.

Additionally or alternatively, the user device may be caused to use the secure key information in securing communication associated with a receiving software application executed on the client device by coordinating with other software applications executed on the client device. For example, a receiving software application may encrypt and/or decrypt communications using one or more companion software applications. The companion software applications may include email applications, chat applications, messaging applications, or other synchronous or asynchronous communications.

Additionally or alternatively, the user device may be caused to use the secure key information in encrypting and/or decrypting stored on the user device via a receiving software application executed on the user device. The data encrypted and/or decrypted may be controlled by the service provider device in communication with the user device via the receiving software application, or may be controlled by the user controlling the software application directly on the user device.

### Example Device Security Verification Processes

FIGS. 5A, 5B, and 6 illustrate various device verification processes. Each device verification performed by a device-identity management system may improve the overall system security by further improving the trustworthiness of the device-identity information received as serving as a proxy for a user identity.

In this regard, FIG. 5A illustrates an example process for device location verification process, for example performed by a device-identity management system embodied by the apparatus 200. The operations illustrated may be performed as a subroutine in a key transmission process, such as that illustrated by the operations depicted and described above with respect to FIG. 4.

At block 502A, the apparatus 200 includes means, such as device security verification module 214, communications module 208, processor 202, and/or the like, configured to identify a device location associated with the user device. In some embodiments, an earlier received transmission from the user device may include a device location. For example, the key transmission request transmitted at block 402 in FIG. 4 may include a device location. Alternatively, the apparatus 200 may be configured to identify the device location by requesting a device location from the user device and/or a third-party device. The device location may be received in response.

At optional block 504A, the apparatus 200 includes means, such as device security verification module 214, communications module 208, processor 202, and/or the like, configured to retrieve a historical device location set associated with the user device or device-identity information. In some embodiments, the apparatus 200 is configured to store historical device locations associated with each user device associated with device-identity information, and the apparatus 200 may retrieve the historical device locations based on the earlier received device-identity information. Additionally or alternatively, the apparatus 200 may retrieve historical device locations from one or more third-party systems, devices, or the like. For example, the apparatus 200 may be configured to request historical device locations from one or more third-party systems configured to store user device locations in a repository. In some embodiments, the historical device locations may be associated with a device identifier that uniquely identifies the user device. In other embodiments, the historical device locations may be associated with device-identity information.

At block 506A, the apparatus 200 includes means, such as device security verification module 214, and/or processor 202, configured to generate a location area based on at least one selected from the group of (1) the user device and (2) the device-identity information. In some embodiments, the dynamic location area is based on the historical device location set retrieved based on the user device and/or device-identity information. In some embodiments, the location area may be a static location area. The static location area may have been previously generated associated with the user device and/or device-identity information, and may be retrieved from a repository for storing the static location area. In other embodiments, the location area may be embodied by a dynamic location area. The apparatus 200 may include means configured to generate the dynamic location area. For example, the apparatus 200 may be configured to generate the dynamic location area using one or more machine learning models, algorithms, and/or artificial intelligence systems. The machine learning models, algorithms, and/or artificial intelligence systems may be trained to generate a dynamic location area based on the historical device location set. In some embodiments, the dynamic location area may be generated by one or more known machine learning implementations, including but not limited to, regression models, support vector machines, neural networks, decision trees, or the like.

At decision 508A, the apparatus 200 includes means, such as device security verification module 214, processor 202, and/or the like, configured to determine whether the device location is within the dynamic location area. The apparatus 200 may utilize one or more location comparison algorithms for determining whether the device location is within the identified location area. If the apparatus 200 determines the device location is not within the dynamic location area, flow continues to block 510A. At block 510A, the request from the user device is rejected and the process terminates. In some embodiments, the user device may receive a response indicating the request has been rejected. By rejecting the request, the apparatus 200 will not provide secure key information, for example to prevent requests transmitted by user devices in a location not associated with the user device and thus likely fraudulent.

If the apparatus 200 determines the device location is within the dynamic location area, flow continues to block 512A. At block 512A, the subroutine ends and a main process continues. In some embodiments, flow then returns to one of the operations illustrated in FIG. 4 where security verification processes were initiated. In some embodiments, another security verification process begins at block 512A.

FIG. 5B illustrates another example device location verification process, for example performed by a device-identity management system embodied by the apparatus 200. The operations illustrated may be performed as a subroutine in a key transmission process, such as that illustrated by the operations depicted and described above with respect to FIG. 4.

At block 502A, the apparatus 200 includes means, such as device security verification module 214, communications module 208, processor 202, and/or the like, configured to identify a device location associated with the user device. In some embodiments, an earlier received transmission from the user device may include a device location. For example, the key transmission request transmitted at block 402 in FIG. 4 may include a device location. Alternatively, the apparatus 200 may be configured to identify the device location by requesting a device location from the user device and/or a third-party device. The device location may be received in response.

At optional block 504A, the apparatus 200 includes means, such as device security verification module 214, communications module 208, processor 202, and/or the like, configured to retrieve a historical device location set associated with the user device or device-identity information. In some embodiments, the apparatus 200 is configured to store historical device locations associated with each user device associated with device-identity information, and the apparatus 200 may retrieve the historical device locations based on the earlier received device-identity information. Additionally or alternatively, the apparatus 200 may retrieve historical device locations from one or more third-party systems, devices, or the like. For example, the apparatus 200 may be configured to request historical device locations from one or more third-party systems configured to store user device locations in a repository. In some embodiments, the historical device locations may be associated with a device identifier that uniquely identifies the user device. In other embodiments, the historical device locations may be associated with device-identity information.

At decision 508B, the apparatus 200 includes means, such as device security verification module 214, processor 202, and/or the like, configured to determine whether the received device location is likely fraudulent based on a historical device location set. In some embodiments, the apparatus 200 may utilize one or more trained machine learning algorithms, artificial intelligence, or the like, trained to output a determination of whether the device location is like fraudulent. For example, the artificial intelligence and/or machine learning model(s) may be configured to identify patterns associated with device locations accessed by the user device based on the device location history. The machine learning model(s) and/or artificial intelligence(s) may be trained to output a determination as to whether the device location is likely fraudulent. Alternatively, the machine learning model(s) and/or artificial intelligence(s) may be trained to output a fraud likelihood score that may be compared to a predetermined fraud likelihood threshold, such that the device location is likely fraudulent if the fraud likelihood score satisfies the predetermined fraud likelihood threshold.

If the apparatus 200 determines the device location is within the dynamic location area, flow continues to block 512A. At block 512A, the subroutine ends and a main process continues. In some embodiments, flow then returns to one of the operations illustrated in FIG. 4 where security verification processes were initiated. In some embodiments, another security verification process begins at block 512A.

FIG. 6 illustrates an example SIM age verification process, for example performed by a device-identity management system embodied by the apparatus 200. The operations illustrated may be performed as a subroutine in a key transmission process, such as that illustrated by the operations depicted and described above with respect to FIG. 4. For example, the subroutine may begin at block 406.

At block 602, the apparatus 200 includes means, such as device security verification module 214, communications module 208, processor 202, and/or the like, configured to determine a subscriber identity module history associated with the device-identity information. The apparatus 200 may communicate with various third-party systems (e.g. a carrier device or system, an industry consortium device, or the like) to retrieve and/or determine the subscriber identity module history. In some embodiments the subscriber identity module history includes at least a SIM age for a current, or newest, SIM associated with the device-identity information. For example, the subscriber identity module history may be retrieved from a wireless carrier device, which maintains information and/or reports regarding SIM replacements associated with device-identity information (e.g., SIM replacements associated with a particular phone number).

At block 604, the apparatus 200 includes means, such as device security verification module 214, processor 202, and/or the like, configured to determine a minimum module age threshold. The minimum module age threshold represents a threshold age such that a SIM that is newer than the minimum module age threshold is considered untrustworthy (for example, because a malicious user may have replaced the SIM using social engineering). In some embodiments, the apparatus 200 may determine the minimum module age threshold using a predetermined algorithm and/or policy. In other embodiments, the minimum module age threshold may be determined based on user behavior associated with the user device and/or device-identity information. For example, a user identified using device-identity information that often replaces their SIM may be associated with a lower minimum module age threshold. In some embodiments, other methods may be utilized to determine a minimum module age threshold, for example where the minimum module age threshold is received from the user via the user device.

At block 606, the apparatus 200 includes means, such as device security verification module 214, and/or processor 202, configured to determine whether the subscriber identity module history satisfies the minimum module age threshold. In some embodiments, the subscriber identity module history satisfies the minimum module age threshold when the current SIM age in the subscriber identity module history (associated with a SIM in use for the device-identity information) exceeds the minimum module age threshold. In other words, a request received from a user device may be rejected if the SIM in use is newer than the minimum module age threshold determined by the apparatus 200.

If the apparatus 200 determines the subscriber identity module history does not satisfy the minimum module age threshold, flow continues to block 510A. At block 510A, the request from the user device is rejected and the process terminates. In some embodiments, the user device may receive a response indicating the request has been rejected. By rejecting the request, the apparatus 200 will not provide secure key information, for example to prevent requests transmitted by user devices where a SIM has recently been replaced and thus is more likely to have been socially engineered and fraudulent.

If the apparatus 200 determines the subscriber identity module history does satisfy the minimum module age threshold, flow continues to block 512A. At block 512A, the subroutine ends and a main process continues. In some embodiments, flow then returns to one of the operations illustrated in FIG. 4 where security verification processes were initiated. In some embodiments, another security verification process begins at block 512A.

### Conclusion

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the inventions set forth herein will come to mind to one skilled in the art to which these inventions pertain having the benefit of the teachings presented in the foregoing description and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A device-identity management system configured to manage storage of certificate information in a manner associated with device-identity information and facilitate secure communication between a user device and a service provider device, the certificate information comprising at least a private key associated with the device-identity information, the device-identity management system comprising at least one processor and at least one memory, the at least one memory having computer-coded instructions therein, wherein the computer-coded instructions, when executed by the at least one processor, cause the device-identity management system to:
receive, at the device-identity management system, from the user device, a secure key request indicative of access by the user device of a link configured by the service provider device in response to the service provider device receiving a request for services from the user device, the secure key request comprising at least device-identity information, the secure key request transmitted over a carrier network comprising at least a carrier device configured to inject the device-identity information in the secure key request via header enrichment;
retrieve, from a secured key storage, the private key associated with the device-identity information; and
transmit, from the device-identity management system to the user device over a secured network, secure key information based on the private key.

2. The device-identity management system of claim 1, wherein the secure key information comprises the private key.

3. The device-identity management system of claim 1, further caused to:
generate a derivative key based on the retrieved private key; and
transmit the secured key information from the device-identity management system to the service provider device,
wherein the secured key information comprises the derivative key.

4. The device-identity management system of claim 1, further caused to:
generate a session key based on the retrieved private key,
wherein the secure key information comprises the session key.

5. The device-identity management system of claim 1, further caused to:
generate a session key based on the retrieved private key; and
generate an encrypted session key based on the session key,
wherein the secure key information comprises the encrypted session key, and wherein transmission of the secure key information comprising the encrypted secret key causes the user device to transmit the encrypted session key to the service provider device.

6. The device-identity management system of claim 1, further caused to:
generate a session key based on the retrieved private key;
generate an encrypted session key based on the session key; and
transmit the encrypted session key from the device-identity management system to the service provider device,
wherein the secure key information comprises at least one selected from the group of (1) the session key and (2) the encrypted session key.

7. The device-identity management system of claim 1, further caused to:
identify a device location associated with the user device;
generate a dynamic location area based on at least one selected from the group of (1) the user device and (2) the device-identity information; and
determine the device location is within the dynamic location area,
wherein the device-identity management system is caused to retrieve the private key in response to the determination that the device location is within the dynamic location area.

8. The device-identity management system of claim 1, further caused to:
identify a device location associated with the user device;
determine a static location area based on at least one selected from the group of (1) the user device and (2) the device-identity information; and
determine the device location is within the static location area,
wherein the device-identity management system is caused to retrieve the private key in response to the determination that the device location is within the static location area.

9. The device-identity management system of claim 1, further caused to:
identify a device location associated with the user device;
retrieve a historical device location set based on at least one selected from the group of (1) the user device and (2) the device-identity information; and
determine, using a trained machine learning model, the device location is not fraudulent based on the historical device location set,
wherein the device-identity management system is caused to retrieve the private key in response to the determination that the device location is within the static location area.

10. The device-identity management system of claim 1, wherein the device-identity information comprises (1) a mobile phone number in a plain-text format, or (2) a mobile phone number in a hashed format.

11. The device-identity management system of claim 1, further caused to:
determine a subscriber identity module history associated with the device-identity information; and
verify the subscriber identity module history satisfies a minimum module age threshold.

12. The device-identity management system of claim 1, further caused to:
cause the user device to store the secure key information in an operating system supported storage associated with the user device.

13. The device-identity management system of claim 1, further caused to:
cause the user device to establish secured communication with the service provider device using the secure key information.

14. The device-identity management system of claim 1, wherein the carrier network is an out-of-band network with respect to the secured network.

15. A computer implemented method for managing storage of certificate information in a manner associated with device-identity information and facilitating secure communication between a user device and a service provider device, the certificate information comprising at least a private key associated with the device-identity information, the method comprising:
receiving, at a device-identity management system, from the user device, a secure key request indicative of access by the user device of a link configured by the service provider device in response to the service provider device receiving a request for services from the user device, the secure key request comprising at least device-identity information, the secure key request transmitted over a carrier network comprising at least a carrier device configured to inject the device-identity information in the secure key request via header enrichment;
retrieving, from a secured key storage, the private key associated with the device-identity information; and
transmitting, from the device-identity management system to the user device over a secured network, secure key information based on the private key.

16. The computer-implemented method of claim 15, wherein the secure key information comprises the private key.

17. The computer-implemented method of claim 15, further comprising:
generating a derivative key based on the retrieved private key; and
transmitting the secured key information from the device-identity management system to the service provider device,
wherein the secured key information comprises the derivative key.

18. The computer-implemented method of claim 15, further comprising:
generating a session key based on the retrieved private key, wherein the secure key information comprises the session key.

19. The computer-implemented method of claim 15, further comprising:
generating a session key based on the retrieved private key; and
generating an encrypted session key based on the session key,
wherein the secure key information comprises the encrypted session key, and wherein transmitting the secure key information comprising the encrypted secret key causes the user device to transmit the encrypted session key to the service provider device.

20. The computer-implemented method of claim 15, further comprising:
generating a session key based on the retrieved private key;
generating an encrypted session key based on the session key; and
transmitting the encrypted session key from the device-identity management system to the service provider device,
wherein the secure key information comprises at least one selected from the group of (1) the session key and (2) the encrypted session key.

21. The computer-implemented method of claim 15, further comprising:
identifying a device location associated with the user device;
generating a dynamic location area based on at least one selected from the group of (1) the user device and (2) the device-identity information; and
determining the device location is within the dynamic location area,
wherein retrieving the private key is in response to the determination that the device location is within the dynamic location area.

22. The computer-implemented method of claim 15, further comprising:
identifying a device location associated with the user device;
determining a static location area based on at least one selected from the group of (1) the user device and (2) the device-identity information; and
determining the device location is within the static location area,
wherein retrieving the private key is in response to the determination that the device location is within the static location area.

23. The computer-implemented method of claim 15, further comprising:
identifying a device location associated with the user device;
retrieving a historical device location set based on at least one selected from the group of (1) the user device and (2) the device-identity information; and
determining, using a trained machine learning model, the device location is not fraudulent based on the historical device location set,
wherein retrieving the private key is in response to the determination that the device location is within the static location area.

24. The computer-implemented method of claim 15, wherein the device-identity information comprises (1) a mobile phone number in a plain-text format, or (2) a mobile phone number in a hashed format.

25. The computer-implemented method of claim 15, further comprising:
determining a subscriber identity module history associated with the device-identity information; and
verifying the subscriber identity module history satisfies a minimum module age threshold.

26. The computer-implemented method of claim 15, further comprising:
causing the user device to store the secure key information in an operating system supported storage associated with the user device.

27. The computer-implemented method of claim 15, further comprising:
causing the user device to establish secured communication with the service provider device using the secure key information.

28. The computer-implemented method of claim 15, wherein the carrier network is an out-of-band network with respect to the secured network.

29. A computer program product to manage storage of certificate information in a manner associated with device-identity information and facilitate secure communication between a user device and a service provider device, the certificate information comprising at least a private key associated with the device-identity information, the computer program product comprising a non-transitory computer readable storage medium having computer program instructions stored therein, the computer program instructions configured to, when executed by a processor, cause the processor to:
receive, at a device-identity management system, from the user device, a secure key request indicative of access by the user device of a link configured by the service provider device in response to the service provider device receiving a request for services from the user device, the secure key request comprising at least device-identity information, the secure key request transmitted over a carrier network comprising at least a carrier device configured to inject the device-identity information in the secure key request via header enrichment;
retrieve, from a secured key storage, the private key associated with the device-identity information; and
transmit, from the device-identity management system to the user device over a secured network, secure key information based on the private key.

30. The computer program product of claim 29, wherein the secure key information comprises the private key.

31. The computer program product of claim 29, wherein the computer program instructions further cause the processor to:
generate a derivative key based on the retrieved private key; and
transmit the secured key information from the device-identity management system to the service provider device,
wherein the secured key information comprises the derivative key.

32. The computer program product of claim 29, wherein the computer program instructions further cause the processor to:
generate a session key based on the retrieved private key,
wherein the secure key information comprises the session key.

33. The computer program product of claim 29, wherein the computer program instructions further cause the processor to:
generate a session key based on the retrieved private key; and
generate an encrypted session key based on the session key,
wherein the secure key information comprises the encrypted session key, and wherein transmission of the secure key information comprising the encrypted secret key causes the user device to transmit the encrypted session key to the service provider device.

34. The computer program product of claim 29, wherein the computer program instructions further cause the processor to:
generate a session key based on the retrieved private key;
generate an encrypted session key based on the session key; and
transmit the encrypted session key from the device-identity management system to the service provider device,
wherein the secure key information comprises at least one selected from the group of (1) the session key and (2) the encrypted session key.

35. The computer program product of claim 29, wherein the computer program instructions further cause the processor to:
identify a device location associated with the user device;
generate a dynamic location area based on at least one selected from the group of (1) the user device and (2) the device-identity information; and
determine the device location is within the dynamic location area,
wherein the processor is caused to retrieve the private key in response to the determination that the device location is within the dynamic location area.

36. The computer program product of claim 29, wherein the computer program instructions further cause the processor to:
identify a device location associated with the user device;
determine a static location area based on at least one selected from the group of (1) the user device and (2) the device-identity information; and
determine the device location is within the static location area,
wherein the processor is caused to retrieve the private key in response to the determination that the device location is within the static location area.

37. The computer program product of claim 29, wherein the computer program instructions further cause the processor to:
identify a device location associated with the user device;
retrieve a historical device location set based on at least one selected from the group of (1) the user device and (2) the device-identity information; and
determine, using a trained machine learning model, the device location is not fraudulent based on the historical device location set,
wherein the processor is caused to retrieve the private key in response to the determination that the device location is within the static location area.

38. The computer program product of claim 29, wherein the device-identity information comprises (1) a mobile phone number in a plain-text format, or (2) a mobile phone number in a hashed format.

39. The computer program product of claim 29, wherein the computer program instructions further cause the processor to:
determine a subscriber identity module history associated with the device-identity information; and
verify the subscriber identity module history satisfies a minimum module age threshold.

40. The computer program product of claim 29, wherein the computer program instructions further cause the processor to:
cause the user device to store the secure key information in an operating system supported storage associated with the user device.

41. The computer program product of claim 29, wherein the computer program instructions further cause the processor to:
cause the user device to establish secured communication with the service provider device using the secure key information.

42. The computer program product of claim 29, wherein the carrier network is an out-of-band network with respect to the secured network.

43. An apparatus for managing storage of certificate information in a manner associated with device-identity information and facilitating secure communication between a user device and a service provider device, the certificate information comprising at least a private key associated with the device-identity information, the apparatus comprising:
means for receiving, at a device-identity management system, from the user device, a secure key request indicative of access by the user device of a link configured by the service provider device in response to the service provider device receiving a request for services from the user device, the secure key request comprising at least device-identity information, the secure key request transmitted over a carrier network comprising at least a carrier device configured to inject the device-identity information in the secure key request via header enrichment;
means for retrieving, from a secured key storage, the private key associated with the device-identity information; and
means for transmitting, from the device-identity management system to the user device over a secured network, secure key information based on the private key.

44. The apparatus of claim 43, wherein the secure key information comprises the private key.

45. The apparatus of claim 43, further comprising:
means for generating a derivative key based on the retrieved private key; and
means for transmitting the secured key information from the device-identity management system to the service provider device,
wherein the secured key information comprises the derivative key.

46. The apparatus of claim 43, further comprising:
means for generating a session key based on the retrieved private key,
wherein the secure key information comprises the session key.

47. The apparatus of claim 43, further comprising:
means for generating a session key based on the retrieved private key; and
means for generating an encrypted session key based on the session key,
wherein the secure key information comprises the encrypted session key, and wherein transmitting the secure key information comprising the encrypted secret key causes the user device to transmit the encrypted session key to the service provider device.

48. The apparatus of claim 43, further comprising:
means for generating a session key based on the retrieved private key;
means for generating an encrypted session key based on the session key; and
means for transmitting the encrypted session key from the device-identity management system to the service provider device,
wherein the secure key information comprises at least one selected from the group of (1) the session key and (2) the encrypted session key.

49. The apparatus of claim 43, further comprising:
means for identifying a device location associated with the user device;
means for generating a dynamic location area based on at least one selected from the group of (1) the user device and (2) the device-identity information; and
means for determining the device location is within the dynamic location area,
wherein retrieving the private key is in response to the determination that the device location is within the dynamic location area.

50. The apparatus of claim 43, further comprising:
means for identifying a device location associated with the user device;
means for determining a static location area based on at least one selected from the group of (1) the user device and (2) the device-identity information; and
means for determining the device location is within the static location area,
wherein retrieving the private key is in response to the determination that the device location is within the static location area.

51. The apparatus of claim 43, further comprising:
means for identifying a device location associated with the user device;
means for retrieving a historical device location set based on at least one selected from the group of (1) the user device and (2) the device-identity information; and
means for determining, using a trained machine learning model, the device location is not fraudulent based on the historical device location set,
wherein retrieving the private key is in response to the determination that the device location is within the static location area.

52. The apparatus of claim 43, wherein the device-identity information comprises (1) a mobile phone number in a plain-text format, or (2) a mobile phone number in a hashed format.

53. The apparatus of claim 43, further comprising:
means for determining a subscriber identity module history associated with the device-identity information; and
means for verifying the subscriber identity module history satisfies a minimum module age threshold.

54. The apparatus of claim 43, further comprising:
means for causing the user device to store the secure key information in an operating system supported storage associated with the user device.

55. The apparatus of claim 43, further comprising:
means for causing the user device to establish secured communication with the service provider device using the secure key information.

56. The apparatus of claim 43, wherein the carrier network is an out-of-band network with respect to the secured network.
